(19) United States
(12) Patent Application Publication
(10) Pub. No.: US 2026/0165384 A1
(43) Pub. Date: Jun. 18, 2026

(54) HEATER ASSEMBLY AND AEROSOL-GENERATING DEVICE COMPRISING SAME

(71) Applicants: KT&G CORPORATION, Daejeon (KR); KOREA ELECTROTECHNOLOGY RESEARCH INSTITUTE, Gyeongsangnam-do (KR)

(72) Inventors: In Su PARK, Daejeon (KR); Chan Min KWON, Daejeon (KR); Tae Kyun KIM, Daejeon (KR); Mi Jeong LEE, Daejeon (KR); John Tae LEE, Daejeon (KR); Tae Kyung LEE, Daejeon (KR); Dae Ho KIM, Gyeongsangnam-do (KR); Ji Won SHIN, Gyeongsangnam-do (KR)

(73) Assignees: KT&G CORPORATION, Daejeon (KR); KOREA ELECTROTECHNOLOGY RESEARCH INSTITUTE, Gyeongsangnam-do (KR)

(21) Appl. No.: 18/994,565

(22) PCT Filed: Aug. 31, 2023
(86) PCT No.: PCT/KR2023/013010

§ 371 Date: Jan. 14, 2025

(30) Foreign Application Priority Data
Aug. 31, 2022 (KR) 10-2022-0110268
Aug. 30, 2023 (KR) 10-2023-0114706

(51) Int. Cl. A24F 40/465

(52) U.S. Cl. CPC A24F 40/465

(57) ABSTRACT

A heater assembly for heating an aerosol generating article includes a resonating unit including a case that includes an accommodation space configured to accommodate the aerosol generating article and an opening through which the aerosol generating article is inserted, a plurality of plates arranged apart from each other along a circumferential direction of the aerosol generating article accommodated in the accommodation space, and a connecting portion connecting the plurality of plates to the case, and a coupler configured to supply microwaves to at least one of the plurality of plates to generate microwave resonance in the resonating unit to heat the aerosol generating article.

### TECHNICAL FIELD

One or more embodiments relate to a heater assembly capable of generating aerosols by heating an aerosol generating article with a dielectric heating method, and an aerosol generating device including the heater assembly.

### BACKGROUND ART

Recently, there is an increasing demand for alternative methods to overcome shortcomings of general cigarettes. For example, there is an increasing demand for a method of generating aerosols by heating a cigarette (or an ‘aerosol generating article’) by using an aerosol generating device, rather than by burning cigarettes.

A microwave heating technique is a method of heating an object by using the principle of dielectric heating. When an aerosol generating article is heated using the microwave heating technique, an aerosol generating material in the aerosol generating article may be quickly heated.

A microwave heating technique used in industrial settings generally utilizes magnetrons that output microwaves at a kilowatt (KW) level. Microwaves for domestic use are also designed to output microwave power ranging from about 700 watts (W) to about 1000 W.

To implement an aerosol generating device capable of heating an aerosol generating article using the microwave heating technique, the aerosol generating device should be designed to be compact, considering its portability.

In addition, the energy efficiency related to a heating operation using electric energy needs to be secured to ensure users to carry the aerosol generating device and use the same for a sufficient period of time. To reduce energy loss in the aerosol generating device employing the microwave heating technique, a cavity Q-factor of a resonator has to be low to minimize power loss caused by surface currents generated on a conductor surface of the resonator.

When microwaves generated by the resonator fail to be converted into heat used to heat an aerosol generating material (medium) in the aerosol generating article and instead generate heat on the conductor surface of the resonator, a heater assembly including the resonator and the aerosol generating device may be overheated in addition to the increase in the energy loss.

### DISCLOSURE

### Technical Problem

One or more embodiments provide a heater assembly and an aerosol generating device, which are capable of heating an aerosol generating article by using microwaves.

One or more embodiments provide a heater assembly and an aerosol generating device, which are designed to have a low cavity Q-factor and heat an aerosol generating article with high energy efficiency.

One or more embodiments provide a heater assembly and an aerosol generating device, with minimized power loss caused by surface currents on a resonator and reduced heat generation.

The effects according to one or embodiments are not limited to the effects described above, and unmentioned effects will be clearly understood by one of ordinary skill in the art from the present specification and the accompanying drawings.

### Technical Solution

A heater assembly for heating an aerosol generating article, according to an embodiment, includes a resonating unit including a case that includes an accommodation space configured to accommodate the aerosol generating article and an opening through which the aerosol generating article is inserted, a plurality of plates arranged apart from each other along a circumferential direction of the aerosol generating article accommodated in the accommodation space, and a connecting portion connecting the plurality of plates to the case, and a coupler configured to supply microwaves to at least one of the plurality of plates to generate microwave resonance in the resonating unit to heat the aerosol generating article.

One ends of the plurality of plates may be connected to the connecting portion, and other ends of the plurality of plates may be spaced apart from each other and open.

The other ends of the plurality of plates may face the opening.

The plurality of plates may be symmetrically arranged with respect to the center of the aerosol generating article in a lengthwise direction of the aerosol generating article.

The plurality of plates may include two plates arranged at opposite locations with respect to the center of the aerosol generating article in a lengthwise direction of the aerosol generating article.

The plurality of plates may extend along a lengthwise direction of the aerosol generating article, and at least a portion of the plurality of plates may be curved to protrude outward from the center of the aerosol generating article in the lengthwise direction of the aerosol generating article.

The coupler may penetrate the case and contacts any one of the plurality of plates.

The coupler may be arranged adjacent to the connecting portion.

The case may be spaced apart from the plurality of plates.

The case may be spaced apart from the plurality of plates, and the heater assembly may further include a dielectric between the case and the plurality of plates.

An end of the dielectric may protrude towards the opening from the ends of the plurality of plates.

The end of the dielectric may be in contact with or spaced apart from an inner surface of the case.

The heater assembly may further include a support tube inserted into the plurality of plates and configured to support the aerosol generating article.

The plurality of plates may extend in one direction, and a direction, along which the aerosol generating article is inserted into the accommodation space through the opening, may intersect with the one direction.

According to other embodiments, an aerosol generating device includes
a heater assembly for heating an aerosol generating article, the heating assembly including a resonating unit including a case that includes an accommodation space configured to accommodate the aerosol generating article and an opening through which the aerosol generating article is inserted, a plurality of plates arranged apart from each other along a circumferential direction of the aerosol generating article accommodated in the accommodation space, and a connecting portion connecting the plurality of plates to the case, and a coupler configured to supply microwaves to at least one of the plurality of plates to generate microwave resonance in the resonating unit to heat the aerosol generating article, and
an oscillating unit configured to generate high-frequency microwave power and supply the high-frequency microwave power to the heater assembly.

### Advantageous Effects

One or more embodiments provide a heater assembly and an aerosol generating device, which are capable of heating an aerosol generating article by using microwaves.

In the heater assembly and the aerosol generating device according to one or more embodiments, because an aerosol generating material (medium) of the aerosol generating article may be placed as a dielectric material within a resonating unit including a plurality of plates, a sufficient electric field for aerosol generation may be formed while reducing the overall size of the resonating unit.

In the heater assembly and the aerosol generating device according to one or more embodiments, the size of the resonating unit is reduced based on a structure in which dielectrics are placed in a dielectric accommodation space, to decrease a mounting space required for the resonating unit in the aerosol generating device, thereby enabling miniaturization of the aerosol generating device.

Also, in the heater assembly and the aerosol generating device according to one or more embodiments, the resonating unit may be designed to have a low cavity Q-factor and thus heat the aerosol generating article with high energy efficiency.

Furthermore, one or more embodiments provide a heater assembly and an aerosol generating device, with minimized power loss caused by surface currents on the resonator and reduced heat generation.

Moreover, as triple resonance occurs in the resonating unit of the heater assembly and the aerosol generating device, the aerosol generating article may be uniformly and effectively heated.

Also, in the heater assembly and the aerosol generating device according to one or more embodiments, resonance peaks are formed at a portion corresponding to an open end of the resonating unit, and a strong electric field may be formed accordingly. Because a portion of the aerosol generating article, which includes a dielectric material (a dielectric), is arranged to correspond to a region where the electric field of the resonating unit is the strongest, the dielectric heating efficiency of heating the aerosol generating article may be improved.

The effects according to one or embodiments are not limited to the effects described above, and unmentioned effects will be clearly understood by one of ordinary skill in the art from the present specification and the accompanying drawings.

### DESCRIPTION OF DRAWINGS

FIG. 1 is a perspective view of an aerosol generating device according an embodiment;

FIG. 2 is an internal block diagram of an aerosol generating device according to an embodiment;

FIG. 3 is an internal block diagram of a dielectric heater illustrated in FIG. 2;

FIG. 4 is a perspective view of a heater assembly according to an embodiment;

FIG. 5 is a cross-sectional view of the heater assembly illustrated in FIG. 4;

FIG. 6 is a schematic perspective view of a heater assembly according to another embodiment.

FIG. 7 is a schematic perspective view of a heater assembly according to another embodiment.

FIG. 8 is a side view schematically showing the electric field distribution of the heater assembly of FIG. 7.

FIG. 9 is a front view schematically showing the electric field distribution of the heater assembly of FIG. 7.

FIG. 10 is a perspective view schematically showing the heating density distribution of an aerosol generating article heated by the heater assembly of FIG. 7.

FIG. 11 is a schematic perspective view of a partially cutaway portion of a heater assembly according to another embodiment.

FIG. 12 is an exploded perspective view schematically showing components of the heater assembly of FIG. 11.

FIG. 13 is a cross-sectional view of the heater assembly of FIG. 11.

FIG. 14 is a perspective view schematically showing the electric field distribution of the heater assembly of FIG. 11.

FIG. 15 is a perspective view schematically showing the heating density distribution of an aerosol generating article heated by the heater assembly of FIG. 11.

FIG. 16 is a schematic perspective view of a heater assembly according to another embodiment.

FIG. 17 is a schematic perspective view of a heater assembly according to another embodiment.

FIG. 18 is a cross-sectional view of the heater assembly of FIG. 17.

FIG. 19 is a schematic cross-sectional view of a heater assembly according to another embodiment.

FIG. 20 is a schematic perspective view of a heater assembly according to another embodiment.

FIG. 21 is a schematic perspective view of a partially cutaway portion of a heater assembly according to another embodiment.

### BEST MODE

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

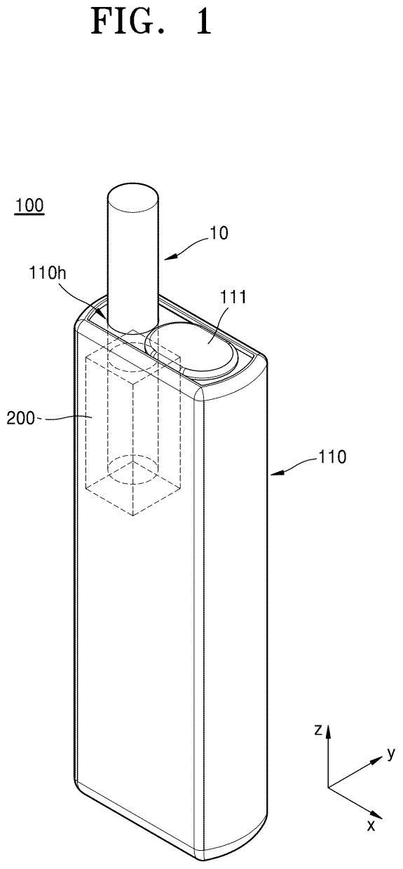

FIG. 1 is a perspective view of an aerosol generating device according to an embodiment.

Referring to FIG. 1, the aerosol generating device 100 according to an embodiment may include a housing 110 accommodating an aerosol generating article 10, and a heater assembly 200 configured to heat the aerosol generating article 10 accommodated in the housing 110.

The housing 110 may form an overall exterior of the aerosol generating device 100 and components of the aerosol generating device 100 may be arranged in an internal space (or a mounting space) of the housing 110. For example, the heater assembly 200, a battery, a processor, and/or a sensor may be arranged in the internal space of the housing 110, but the components arranged in the internal space are not limited thereto.

An insertion hole 110h may be formed in one area of the housing 110, and at least one area of the aerosol generating article 10 may be inserted into the housing 110 through the insertion hole 110h. For example, the insertion hole 110h may be formed in one area of a top surface (e.g., a surface facing a z direction) of the housing 110, but a location of the insertion hole 110h is not limited thereto. According to another embodiment, the insertion hole 110h may be formed in one area of a side surface (e.g., a surface facing an x direction) of the housing 110.

The heater assembly 200 is arranged in the internal space of the housing 110 and heat the aerosol generating article 10 inserted into or accommodated in the housing 110 through the insertion hole 110h. For example, the heater assembly 200 may heat the aerosol generating article 10 by being arranged to surround at least one area of the aerosol generating article 10 inserted into or accommodated in the housing 110.

According to an embodiment, the heater assembly 200 may heat the aerosol generating article 10 by using a dielectric heating method. In the disclosure, the dielectric heating method is a method of heating a dielectric that is an object to be heated, by using resonance of microwaves and/or an electric field (or including a magnetic field) of microwaves. Microwaves are an energy source for heating the object to be heated and are generated by high-frequency power, and thus, ‘microwaves’ may be interchangeably used with ‘microwave power.’

Charges or ions of the dielectric included in the aerosol generating article 10 may vibrate or rotate inside the heater assembly 200 by microwave resonance, and heat may be generated in the dielectric by frictional heat generated when the charges or ions vibrate or rotate, and thus, the aerosol generating article 10 may be heated.

When the aerosol generating article 10 is heated by the heater assembly 200, aerosols may be generated from the aerosol generating article 10. In the disclosure, aerosols may refer to gas particles generated when the air and vapor generated as the aerosol generating article 10 is heated are mixed with each other.

The aerosols generated from the aerosol generating article 10 may be discharged to the outside of the aerosol generating device 100 by passing through the aerosol generating article 10 or through an empty space between the aerosol generating article 10 and the insertion hole 110h. A user may smoke by bringing his/her mouth into contact with one area of the aerosol generating article 10 exposed to the outside of the housing 110 and inhale the aerosols discharged to the outside of the aerosol generating device 100.

The aerosol generating device 100 according to an embodiment may further include a cover 111 movably arranged in the housing 110 to open or close the insertion hole 110h. For example, the cover 111 may be slidably combined to the top surface of the housing 110 to expose the insertion hole 110h to the outside of the aerosol generating device 100 or cover the insertion hole 110h so that the insertion hole 110h is not exposed to the outside of the aerosol generating device 100.

According to an embodiment, the cover 111 may expose the insertion hole 110h to the outside of the aerosol generating device 100 at a first location (or an opening location). When the insertion hole 110h is exposed to the outside, the aerosol generating article 10 may be inserted into the housing 110 through the insertion hole 110h.

According to another embodiment, the cover 111 may cover the insertion hole 110h at a second location (or a closing location) so that the insertion hole 110h is not exposed to the outside of the aerosol generating device 100. Here, the cover 111 may prevent external impurities from entering into the heater assembly 200 through the insertion hole 110h when the aerosol generating device 100 is not used.

FIG. 1 illustrates only the aerosol generating device 100 for heating the aerosol generating article 10 in a solid state, but the aerosol generating device 100 is not limited thereto.

An aerosol generating device according to another embodiment may generate aerosols by heating an aerosol generating material in a liquid or gel state, instead of the aerosol generating article 10 in a solid state, through the heater assembly 200.

An aerosol generating device according to another embodiment may include the heater assembly 200 configured to heat the aerosol generating article 10 and a cartridge (or a vaporizer) including an aerosol generating material in a liquid or gel state and configured to heat the aerosol generating material. Aerosols generated from the aerosol generating material may move to the aerosol generating article 10 along an airflow passage communicated with the cartridge and the aerosol generating article 10 to each other and be mixed with aerosols generated from the aerosol generating article 10, and then transmitted to a user through the aerosol generating article 10.

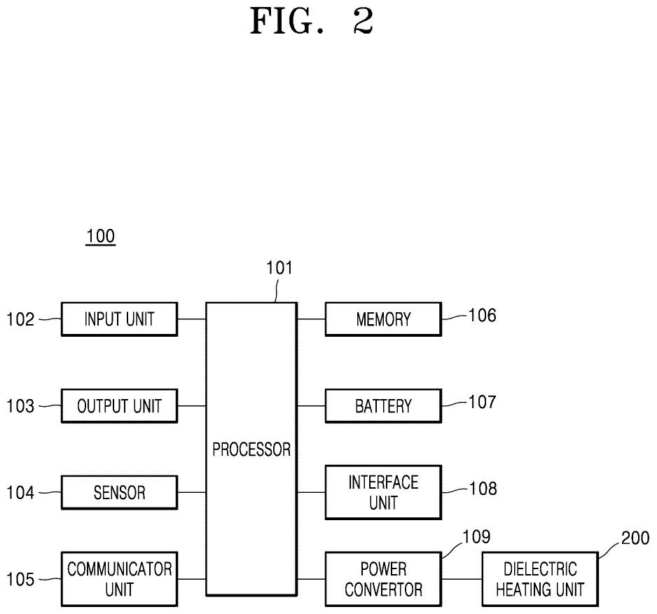

FIG. 2 is an internal block diagram of the aerosol generating device according to an embodiment.

Referring to FIG. 2, the aerosol generating device 100 may include an input unit 102, an output unit 103, a sensor 104, a communicator 105, a memory 106, a battery 107, an interface 108, a power converter 109, and a dielectric heater 200. However, an internal structure of the aerosol generating device 100 is not limited to those illustrated in FIG. 2. According to a design of the aerosol generating device 100, some of the components shown in FIG. 2 may be omitted or a new component may be added.

The input unit 102 may be configured to receive a user input. For example, the input unit 102 may be provided as a single pressurizing type push button. In another example, the input unit 102 may be a touch panel including at least one touch sensor. The input unit 102 may transmit an input signal to a processor 101. The processor 101 may supply power to the dielectric heater 200 based on the user input or output a user notification by controlling the output unit 103.

The output unit 103 may output information about a state of the aerosol generating device 100. The output unit 103 may output information about a charging/discharging state of the battery 107, a heating state of the dielectric heater 200, an insertion state of the aerosol generating article 10, and an error of the aerosol generating device 100. In this regard, the output unit 103 may include a display, a haptic motor, and a sound output unit.

The sensor 104 may sense a state of the aerosol generating device 100 or a state around the aerosol generating device 100, and transmit sensed information to the processor 101. Based on the sensed information, the processor 101 may control the aerosol generating device 100 to perform various functions, such as controlling heating of the dielectric heater 200, limiting smoking, determining whether the aerosol generating article 10 is inserted, displaying a notification, and the like.

The sensor 104 may include a temperature sensor, a puff sensor, and an insertion detection sensor.

The temperature sensor may detect a temperature inside the dielectric heater 200 in a non-contact manner or may directly obtain a temperature of a resonator by contacting the dielectric heater 200. According to an embodiment, the temperature sensor may detect a temperature of the aerosol generating article 10. Also, the temperature sensor may be arranged adjacent to the battery 107 to obtain a temperature of the battery 107. The processor 101 may control power supplied to the dielectric heater 200, based on temperature information of the temperature sensor.

The puff sensor may detect a puff of the user. The puff sensor may detect a puff of the user, based on at least one of a temperature change, a flow change, a power change, and a pressure change. The processor 101 may control power supplied to the dielectric heater 200, based on puff information of the puff sensor. For example, the processor 101 may count the number of puffs and block power supplied to the dielectric heater 200 when the number of puffs reaches a pre-set maximum number of puffs. In another example, the processor 101 may block power supplied to the dielectric heater 200 when a puff is not detected for a pre-set period of time or more.

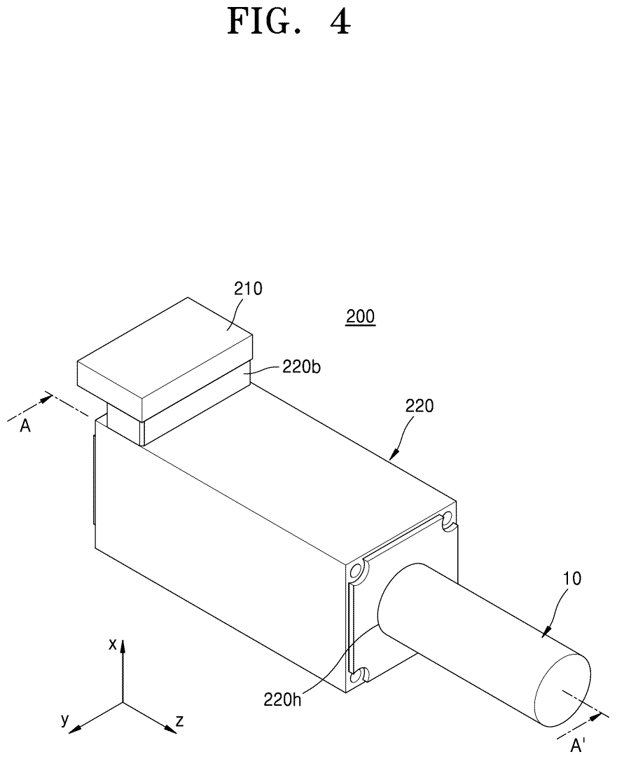

The insertion detection sensor may be arranged inside an accommodating space 220h of FIG. 4 or adjacent to the accommodating space 220h and detect insertion and removal of the aerosol generating article 10 accommodated in the insertion hole 110h. For example, the insertion detection sensor may include an inductive sensor and/or a capacitance sensor. The processor 101 may supply power to the dielectric heater 200 when the aerosol generating article 10 is inserted into the insertion hole 110h.

According to an embodiment, the sensor 104 may further include a reuse detection sensor, a motion detection sensor, a humidity sensor, an atmospheric pressure sensor, a magnetic sensor, a cover removal detection sensor, a location sensor (global positioning system (GPS)), and a proximity sensor. Because the functions of each sensor may be intuitively inferred by one of ordinary skill in the art from the name, detailed descriptions thereof will be omitted.

The communicator 105 may include at least one communication module for communication with an external electronic device. The processor 101 may control the communicator 105 to transmit information about the aerosol generating device 100 to the external electronic device. Alternatively, the processor 101 may receive information from the external electronic device through the communicator 105 to control the components included in the aerosol generating device 100. For example, information transmitted between the communicator 105 and the external electronic device may include user authentication information, firmware update information, and user smoking pattern information.

The memory 106 is hardware storing various types of data processed in the aerosol generating device 100, and may store data processed and data to be processed by the processor 101. For example, the memory 106 may store an operation time of the aerosol generating device 100, the maximum number of puffs, the current number of puffs, at least one temperature profile, data on the user's smoking pattern, and the like.

The battery 107 may supply power to the dielectric heater 200 such that the aerosol generating article 10 may be heated. Also, the battery 107 may supply power required for operations of other components included in the aerosol generating device 100. The battery 107 may be a rechargeable battery or a detachable and removable battery.

The interface 108 may include a connecting terminal that may be physically connected to the external electronic device. For example, the connecting terminal may include at least one or a combination of a high-definition multimedia interface (HDMI) connector, a universal serial bus (USB) connector, a secure digital (SD) card connector, and an audio connector (e.g., a headphone connector). The interface 108 may transmit or receive information to or from the external electronic device through the connecting terminal, or charge a power source.

The power converter 109 may convert direct current power supplied from the battery 107 into alternating current power. Also, the power converter 109 may provide the alternating current power to the dielectric heater 200. The power converter 109 may be an inverter including at least one switching device and the processor 101 may control on/off of the switching device included in the power convertor 109 to convert direct current power into alternating current power. The power converter 109 may be configured as a full-bridge or a half-bridge.

The dielectric heater 200 may heat the aerosol generating article 10 by using a dielectric heating method. The dielectric heater 200 may be a component corresponding to the heater assembly 200 of FIG. 1.

The dielectric heater 200 may heat the aerosol generating article 10 by using microwaves and/or an electric field of microwaves (hereinafter, referred to as microwaves or microwave power when distinction is not required). A heating method of the dielectric heater 200 may be a method of heating an object to be heated by forming microwaves in a resonance structure, instead of radiating microwaves by using an antenna. The resonance structure will be described below with reference to FIG. 4.

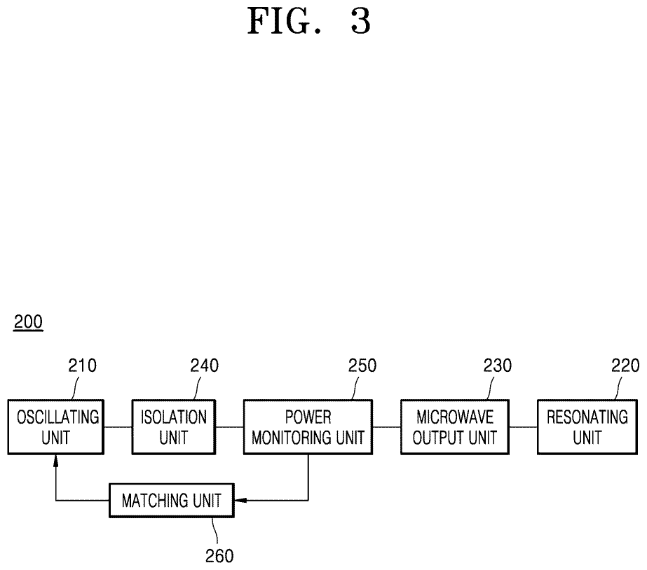

The dielectric heater 200 may output microwaves that is a high frequency to a resonator 220 of FIG. 3. Microwaves may be power in an industrial scientific and medical equipment (ISM) band allowed for heating, but are not limited thereto. The resonator 220 may be designed considering a wavelength of microwaves so that microwaves may resonate in the resonator 220.

The aerosol generating article 10 may be inserted into the resonator 220 and a dielectric material in the aerosol generating article 10 may be heated by the resonator 220. For example, the aerosol generating article 10 may include a polar material and molecules in the polar material may be polarized inside the resonator 220. The molecules may vibrate or rotate according to a polarization phenomenon and the aerosol generating article 10 may be heated by frictional heat generated during such a process. Details about the dielectric heater 200 will be described in detail below with reference to FIG. 3.

The processor 101 may control general operations of the aerosol generating device 100. The processor 101 may be implemented in an array of a plurality of logic gates, or in a combination of a general-purpose microprocessor and a memory storing a program executable by the general-purpose microprocessor. The processor 101 may be implemented in another form of hardware.

The processor 101 may control direct current power supplied from the battery 107 to the power converter 109 or alternating current power supplied from the power convertor 109 to the dielectric heater 200, according to power demand of the dielectric heater 200. According to an embodiment, the aerosol generating device 100 may include a converter configured to boost or lower the direct current power, and the processor 101 may adjust a size of the direct current power by controlling the converter. Also, the processor 101 may control the alternating current power supplied to the dielectric heater 200 by adjusting a switching frequency and duty ratio of the switching device included in the power converter 109.

The processor 101 may control the heating temperature of the aerosol generating article 10 by controlling microwave power of the dielectric heater 200 and a resonating frequency of the dielectric heater 200. Accordingly, an oscillator 210, an isolator 240, a power monitoring unit 250, and a matching unit 260 of FIG. 3 described below may be some components of the processor 101.

The processor 101 may control microwave power of the dielectric heater 200, based on temperature profile information stored in the memory 106. In other words, a temperature profile may include information about a target temperature of the dielectric heater 200 according to time, and the processor 101 may control microwave power of the dielectric heater 200 according to time.

The processor 101 may adjust a frequency of microwaves so that the resonating frequency of the dielectric heater 200 is not uniform. The processor 101 may track, in real time, a change in the resonating frequency of the dielectric heater 200 according to the heating of an object to be heated, and control the dielectric heater 200 so that a microwave frequency according to the changed resonating frequency is output. In other words, the processor 101 may change the microwave frequency in real time regardless of the pre-stored temperature profile.

FIG. 3 is an internal block diagram of the dielectric heater 200 of FIG. 2.

Referring to FIG. 3, the dielectric heater 200 may include the oscillator, the isolator 240, the power monitoring unit 250, the matching unit 260, a microwave output unit 230, and the resonator 220. However, an internal configuration of the dielectric heater 200 is not limited to that shown in FIG. 3. According to a design of the dielectric heater 200, some of the components shown in FIG. 3 may be omitted or a new component may be added.

The oscillator 210 may receive alternating current power from the power converter 109 and generate microwave power of high frequency. According to an embodiment, the power converter 109 may be included in the oscillator 210. The microwave power may be selected from frequency bands of 915 MHz, 2.45 GHz, and 5.8 GHz, which are included in ISM bands.

The oscillator 210 may include a solid-state-based radio frequency (RF) generating apparatus and generate the microwave power by using the same. The solid-state-based RF generating apparatus may be implemented in a semiconductor. When the oscillator 210 is implemented in a semiconductor, the dielectric heater 200 may be miniaturized and device lifespan may be increased.

The oscillator 210 may output the microwave power towards the resonator 220. The oscillator 210 may include a power amplifier configured to increase or decrease the microwave power and the power amplifier may adjust a size of the microwave power according to control by the processor 101. For example, the power amplifier may decrease or increase amplitude of microwaves. The microwave power may be adjusted by adjusting the amplitude of microwaves.

The processor 101 may adjust the size of the microwave power output from the oscillator 210, based on a pre-stored temperature profile. For example, the temperature profile may include information about a target temperature according to a preheating period and a smoking period, and the oscillator 210 may supply the microwave power of first power during the preheating period and supply the microwave power of second power lower than the first power during the smoking period.

The isolator 240 may block the microwave power input from the resonator 220 towards the oscillator 210. The microwave power output by the oscillator 210 is mostly absorbed by an object to be heated, but part of the microwave power may be reflected at the object to be heated and transmitted back to the oscillator 210, depending on a heating pattern of the object to be heated. This is because impedance viewed from the oscillator 210 to the resonator 220 changes according to depletion of polar molecules due to heating of the object to be heated. The meaning that the impedance viewed from the oscillator 210 to the resonator 220 changes is the same as the meaning that the resonating frequency of the resonator 220 changes. When the microwave power reflected at the resonator 220 is input to the oscillator 210, not only the oscillator 210 malfunctions, but also an expected output performance may not be achieved. The isolator 240 may not return the microwave power reflected at the resonator 220 back to the oscillator 210, but may induce the microwave power in a certain direction and absorb the same. In this regard, the isolator 240 may include a circulator and a dummy load.

The power monitoring unit 250 may monitor each of microwave power output from the oscillator 210 and reflection microwave power reflected at the resonator 220. The power monitoring unit 250 may transmit, to the matching unit 260, information about the microwave power and the reflection microwave power.

The matching unit 260 may match impedance viewed from the oscillator 210 to the resonator 220 with impedance viewed from the resonator 220 to the oscillator 210, so that the reflection microwave power is minimized. Impedance matching may have a same meaning as matching a frequency of the oscillator 210 and the resonating frequency of the resonator 220. Accordingly, to match the impedance, the matching unit 260 may vary a frequency of the oscillator 210. In other words, the matching unit 260 may adjust a frequency of the microwave power output from the oscillator 210 so that the reflection microwave power is minimized. The impedance matching of the matching unit 260 may be performed in real time regardless of the temperature profile.

The oscillator 210, the isolator 240, the power monitoring unit 250, and the matching unit 260 are separate components distinguished from the microwave output unit 230 and the resonator 220 described below, and may be implemented as a microwave source in the form of a chip. Also, according to an embodiment, the oscillator 210, the isolator 240, the power monitoring unit 250, and the matching unit 260 may be implemented as a partial configuration of the processor 101.

The microwave output unit 230 is a component configured to input the microwave power to the resonator 220 and may correspond to a coupler of FIG. 3 and below. The microwave output unit 230 may be implemented in the form of a SubMiniature Version A (SMA), SubMiniature Version B (SMB), Micro Coaxial (MCX), or Micro-Miniature Coaxial (MMCX) connector. The microwave output unit 230 may connect the resonator 220 to the microwave source in the form of a chip so as to transmit microwave power generated in the microwave source to the resonator 220.

The resonator 220 may heat the object to be heated by forming microwaves in a resonance structure. The resonator 220 may include an accommodating space in which the aerosol generating article 10 is accommodated and the aerosol generating article 10 may be dielectrically heated by being exposed to microwaves. For example, the aerosol generating article 10 may include a polar material and molecules in the polar material may be polarized inside the resonator 220 by microwaves. The molecules may vibrate or rotate according to a polarization phenomenon and the aerosol generating article 10 may be heated by frictional heat generated during such a process.

The resonator 220 includes at least one internal conductor for microwaves to resonate, and the microwaves may resonate inside the resonator 220 according to an arrangement, thickness, and length of the internal conductor.

The resonator 220 may be designed in consideration of the wavelength of the microwave such that the microwave may be resonated in the resonator 220. For the microwave to be resonated in the resonator 220, the resonator 220 needs a closed end/short end, in which a cross-section thereof is closed, and an open end opposite to the closed end, wherein at least an area of a cross-section of the open end is open. In addition, it is required that a length between the closed end and the open end is set as an integer multiple of ¼ of the wavelength of the microwave. To reduce the size of the aerosol generating device 100, a ¼ length of the wavelength of the microwave is selected for the resonator 220 of the disclosure. In other words, the length between the closed end and the open end of the resonator 220 may be set as the length of ¼ of the wavelength of the microwave.

The resonator 220 may include a dielectric material-accommodation space. In the dielectric material-accommodation space, which is a component distinguished from the accommodation space of the aerosol generating article 10, a material capable of changing the resonance frequency of an entire portion of the resonator 220 and reducing a size of the resonator 220 is arranged. In an embodiment, a dielectric material having a low microwave absorbance may be accommodated in the dielectric material-accommodation space. This is to prevent heating of the dielectric material itself caused as energy to be delivered to the heating object is delivered to the dielectric material. The absorbance of the microwave may be expressed as the loss tangent, i.e., the ratio of the imaginary part of the complex dielectric constant to the real part of the complex dielectric constant. In an embodiment, a dielectric material having a loss tangent equal to a preset value or smaller may be accommodated in the dielectric material-accommodation space 227, and the preset value may be 1/100. For example, the dielectric may include at least one of quartz, tetrafluoroethylene, and aluminum oxide, or a combination thereof, but is not limited thereto. FIG. 4 illustrates a perspective view of the heater assembly according to an embodiment.

Referring to FIG. 4, the heater assembly 200 according to an embodiment may include the oscillator 210 and the resonator 220. FIG. 4 may illustrate an embodiment of the heater assembly 200 and the dielectric heater 200 described above, and hereinafter, same descriptions will not be repeatedly given.

As the power is provided, the oscillator 210 may generate the microwave in a determined frequency band. The microwave generated in the oscillator 210 may be delivered to the resonator 220 through a coupler (not shown).

The resonator 220 may include the accommodation space 220h accommodating at least an area of the aerosol generating article 10, and may heat the aerosol generating article 10 in the dielectric heating method by resonating the microwave generated in the oscillator 210. For example, due to the resonance of the microwave, electric charges of glycerin included in the aerosol generating article 10 may vibrate or rotate, and friction heat generated during vibration or rotation of the electric charge causes heat generation in glycerin, and thus, the aerosol generating article 10 may be heated.

According to an embodiment, to prevent the microwave generated in the oscillator 210 from being absorbed into the resonator 220, the resonator 220 may include a material having a low microwave absorbance.

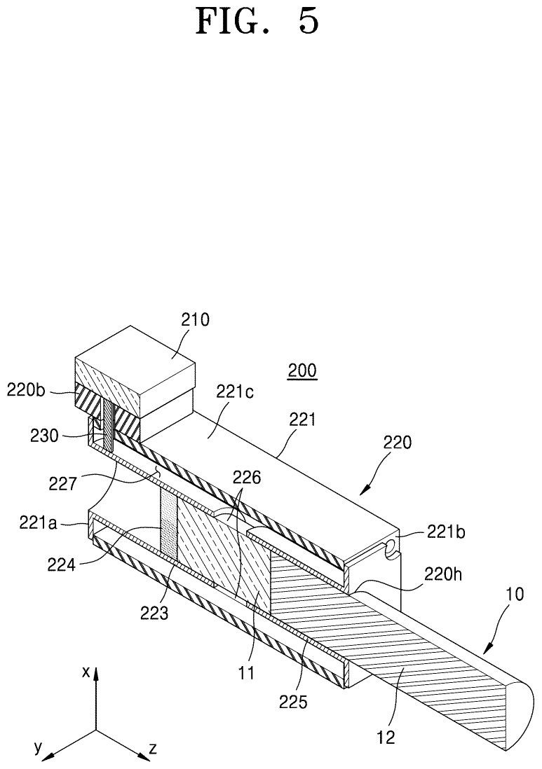

Hereinafter, a detailed structure of the resonator 220 of the heater assembly 200 will be described with reference to FIG. 5.

FIG. 5 illustrates a cross-sectional view of the heater assembly 200 illustrated in FIG. 4. FIG. 5 illustrates a cross-section of the heater assembly 200 illustrated in FIG. 4, taken in an A-A′ direction.

Referring to FIG. 5, the heater assembly 200 according to an embodiment may include the oscillator 210, the resonator 220, and a coupler 230. The components in the heater assembly 200 may be identical or similar to at least one of components in the heater assembly 200 illustrated in FIG. 4, and hereinafter, same descriptions thereof will not be repeatedly given.

As an alternating voltage is applied, the oscillator 210 may generate a microwave in a determined frequency band, and the microwave generated in the oscillator 210 may be delivered to the resonator 220 through the coupler 230.

According to an embodiment, in a process of using the aerosol generating device 100, the oscillator 210 may be fixed to the resonator 220 to prevent separation from the resonator 220. In an example, the oscillator 210 may be fixed onto the resonator 220 by being supported by a bracket 220b protruding in an x direction in an area of the resonator 220. In another example, the resonator 220 may also be fixed onto the resonator 220 in a manner of being attached onto an area of the resonator 220 without the bracket 220b.

Although FIG. 5 only illustrates an embodiment in which the oscillator 210 is fixed to the area in the x direction of the resonator 220, a position of the oscillator 210 is not limited to the embodiment illustrated in FIG. 5. In another embodiment, the oscillator 210 may also be fixed to another area in a−z direction of the resonator 220.

The resonator 220 may be arranged to surround at least an area of the aerosol generating article 10 inserted into the aerosol generating device, and may heat the aerosol generating article 10 by using the microwave generated in the oscillator 210. For example, dielectric materials included in the aerosol generating article 10 may generate heat due to an electric field generated in the resonator 220 due to the microwave, and the aerosol generating article 10 may be heated by the heat generated in the dielectric material.

According to an embodiment, the aerosol generating article 10 may include a tobacco rod 11 and a filter rod 12.

The tobacco rod 11 may include an aerosol generating material, and may be manufactured with a sheet, strands, or cut fillers obtained by finely cutting a tobacco sheet. For example, the aerosol generating material may include at least one of glycerin, propylene glycol, ethylene glycol, dipropylene glycol, diethylene glycol, triethylene glycol, tetraethylene glycol, and oleyl alcohol, but is not limited thereto. In addition, the tobacco rod 11 may include other additive materials such as a savoring agent, a wetting agent, and/or an organic acid. In addition, flavoring liquid such as menthol or moisturizer may be added to the tobacco rod 11 in a manner of being sprayed to the tobacco rod 11.

The filter rod 12 may include a cellulose acetate filter. A shape of the filter rod 12 is not limited. For example, the filter rod 12 may include a cylinder type rod or a tube type rod including a hollow therein. In addition, the filter rod 12 may also include a recess type rod. When the filter rod 12 includes a plurality of segments, at least one of the plurality of segments may be manufactured in another shape.

At least a portion (e.g., glycerin) of the aerosol generating material included in the aerosol generating article 10 may include a dielectric material having polarity in the electric field, and the at least the portion of the aerosol generating material may heat the aerosol generating article 10 by generating heat by the dielectric heating method.

According to an embodiment, the resonator 220 may include an outer conductor 221, a first inner conductor 223, and a second inner conductor 225.

The outer conductor 221 may form an entire outward appearance of the resonator 220, and as an inner portion of the outer conductor 221 is formed in a hollow shape, the components of the resonator 220 may be arranged in the outer conductor 221. The outer conductor 221 may include the accommodation space 220h in which the aerosol generating article 10 may be accommodated, and the aerosol generating article 10 may be inserted into the outer conductor 221 through the accommodation space 220h.

According to an embodiment, the outer conductor 221 may include a first surface 221a, a second surface 221b arranged to face the first surface 221a, and a side surface 221c surrounding an empty space between the first surface 221a and the second surface 221b. At least some (e.g., the first inner conductor 223 and the second inner conductor 225) of the components of the resonator 220 may be arranged in the inner space of the resonator 220 formed by the first surface 221a, the second surface 221b, and the side surface 221c.

The first inner conductor 223 may be formed in a hollow cylinder shape extending in a direction from the first surface 221a of the outer conductor 221 toward the inner space of the outer conductor 221.

According to an embodiment, an area of the first inner conductor 223 may be in contact with the coupler 230 connected to the oscillator 210, and the microwave generated in the oscillator 210 may be delivered to the first inner conductor 223 through the coupler 230. For example, the coupler 230 may be arranged to penetrate the outer conductor 221 and be in contact with the oscillator 210 by an end of the coupler 230 and in contact with an area of the first inner conductor 223 by another end of the coupler 230, and the microwave generated in the oscillator 210 may be delivered to the first inner conductor 223 through the coupler 230.

In this case, to deliver the microwave, the coupler 230 may be arranged to penetrate the outer conductor 221 without being in contact with the outer conductor 221. However, as long as the microwave generated in the oscillator 210 may be delivered to the first inner conductor 223, an arrangement structure of the coupler 230 may be not limited thereto.

A first area formed between the outer conductor 221 and the first inner conductor 223 may be configured to operate as a ‘first resonator’ configured to generate an electric field through resonance of the microwave. The first area may refer to a space formed by the first surface 221a of the outer conductor 221, the side surface 221c, and the first inner conductor 223, and in the first area, an electric field may be generated as a result of resonance of the microwave delivered through the coupler 230.

The second inner conductor 225 may be formed in a hollow cylinder shape extending in a direction from the second surface 221b of the outer conductor 221b into the inner space of the outer conductor 221. In the inner space of the outer conductor 221, the second inner conductor 225 may be arranged apart by a certain distance from the first inner conductor 223, and a gap 226 may be formed between the first inner conductor 223 and the second inner conductor 225.

The second area formed between the outer conductor 221 and the second inner conductor 225 may be configured to operate as a ‘second resonator’ configured to generate an electric field through resonance of the microwave. The second inner conductor 225 and the first inner conductor 223 may be in a coupling (e.g., a capacitive coupling), and due to this coupling relationship, when an electric field is generated in the first area, an induced electric field may be formed in the second area. In the disclosure, ‘a capacitive coupling’ may indicate a coupling relationship in which energy may be delivered due to a capacitance between two conductors.

For example, as the microwave generated from the oscillator 210 is delivered to the first inner conductor 223, an electric field may be formed in the first area as a result of the resonance, and an induced electric field may be generated in the second area formed by the second inner conductor 225 coupled with the outer conductor 221 and the first inner conductor 223.

According to an embodiment, the first area and the second area of the resonator 220 may be configured to operate as a resonator having a ¼ (λ) wavelength of the microwave.

In an embodiment, an end (e.g., an end in the −z direction) of the first area may be formed in a closed end/short end as a cross-section of the first area is closed by the first surface 221a of the outer conductor 221, and another end (e.g., an end in the z direction) of the first area may be formed in an open end as the first surface 221a is not arranged and a cross-section of the other end of the first area is open. In another example, an end (e.g., an end in the −z direction) of the second area may be formed in an open end as an end surface of the second area is open, and another end (e.g., an end in the z direction) may be formed in a closed end/short end as a cross-section of the second area is closed by the second surface 221b of the outer conductor 221.

That is, on an xz plane, the first area and the second area each including the closed end and the open end may be formed in a shape of “U”, and through the aforementioned structure, the first area and the second area may each operate as a resonator having a ¼ wavelength of the microwave.

According to an embodiment, the first inner conductor 223 and the second inner conductor 225 may be formed in a same length with reference to a z axis and may be arranged such that the first area and the second area are symmetric, but the disclosure is not limited thereto.

The aerosol generating article 10 inserted into the inner space of the outer conductor 221 through the accommodation space 220h may be surrounded by the first inner conductor 223 and the second inner conductor 225 and heated in the dielectric heating method.

At least a portion of the electric field generated due to the resonance of the microwave in the first area and/or the second area may be propagated into the first inner conductor 223 and/or the second inner conductor 225 through the gap 226 between the first inner conductor 223 and the second inner conductor 225, and the aerosol generating article 10 surrounded by the first inner conductor 223 and the second inner conductor 225 may be heated by the electric field that has been propagated. For example, the dielectric material included in the aerosol generating article 10 may generate heat due to the electric field propagated through the gap 226, and the aerosol generating article 10 may be heated due to the heat generated from the dielectric material.

In the heater assembly 200 according to an embodiment, by setting diameters of the first inner conductor 223 and the second inner conductor 225 to have a value less than a determined value, it is possible to prevent leakage of the electric field, which has been propagated into the first inner conductor 223 and/or the second inner conductor 225, to the outside of the heater assembly 200 or the resonator 220. In the disclosure, the term ‘determined value’ may indicate a value of the diameters of the first inner conductor 223 and the second inner conductor 225 at which the electric field begins to leak outside of the first inner conductor 223 and/or the second inner conductor 225. For example, when the value of the diameter of the first inner conductor 223 and/or the second inner conductor 225 is equal to or greater than the determined value, a portion of the electric field introduced into the first inner conductor 223 and/or the second inner conductor 225 may leak out to outside of the resonator 220. On the other hand, through a structure in which the value of the diameters of the first inner conductor 223 and the second inner conductor 225 is less than the determined value, the heater assembly 200 according to an embodiment may prevent propagation of the electric field to the outside of the resonator 220, and as a result, leakage of the electric field to the outside of the heater assembly 200 or the resonator 220 may be prevented without additional blocking members.

According to an embodiment, when the aerosol generating article 10 is inserted into the resonator 220 through the accommodation space 220h, the tobacco rod 11 of the aerosol generating article 10 may be arranged at a position corresponding to a position of the gap 226 between the first inner conductor 223 and the second inner conductor 225.

As the electric field generated in the first area and the electric field generated in the second area are introduced into the first inner conductor 223 and/or the second inner conductor 225 through the gap 226, a strongest electric field may be generated in a peripheral area of the gap 226 among inner areas of the resonator 220.

In the heater assembly 200 according to an embodiment, heating efficiency (or ‘dielectric heating efficiency) of the heater assembly 200 may be improved by arranging the tobacco rod 11, which includes the dielectric material generating heat due to the electric field, at a position corresponding to a position of the gap 226 having the strongest electric field.

According to an embodiment, the resonator 220 may further include a closing unit 224 located in the first inner conductor 223 and limiting a direction in which the aerosol generated from the aerosols generating article 10 moves by closing a cross-section of the first inner conductor 223. For example, the closing unit 224 may prevent movement in the −z direction of the aerosols generated from the aerosol generating article 10 by closing the cross-section of the first inner conductor 223.

As the aerosols generated from the aerosol generating article 10 or a droplet generated as a result of liquefaction of the aerosols move in the −z direction and are introduced into another component of the aerosol generating device (e.g., the aerosol generating device 100 illustrated in FIG. 1), misoperation or damage may be caused to the components of the aerosol generating device. On the other hand, in the heater assembly 200 according to an embodiment, misoperation or damage of the components of the aerosol generating device due to the aerosols or droplet may be prevented by limiting the direction in which the aerosols move through the closing unit 224.

According to an embodiment, the resonator 220 may further include a dielectric material-accommodation space 227 for accommodating the dielectric material. The dielectric material-accommodation space 227 may indicate an empty space between the outer conductor 221 and the first inner conductor 223 and the second inner conductor 225, and a dielectric material having a low microwave absorbance may be accommodated in the dielectric material-accommodation space 227. For example, the dielectric material may include at least one of quartz, tetrafluoroethylene, and aluminum oxide, or a combination thereof, but is not limited thereto.

In the heater assembly 200 according to an embodiment, by arranging the dielectric material in the dielectric material-accommodation space 227, the electric field identical to an electric field of the resonator 220 and not including the dielectric material may be generated while reducing an entire size of the resonator 220. That is, in the heater assembly 200 according to an embodiment, a mounting space of the resonator 220 in the aerosol generating device may be reduced by reducing the size of the resonator 220 through the dielectric material arranged in the dielectric material-accommodation space 227, and as a result thereof, the size of the aerosol generating device 100 may be reduced.

### MODE FOR INVENTION

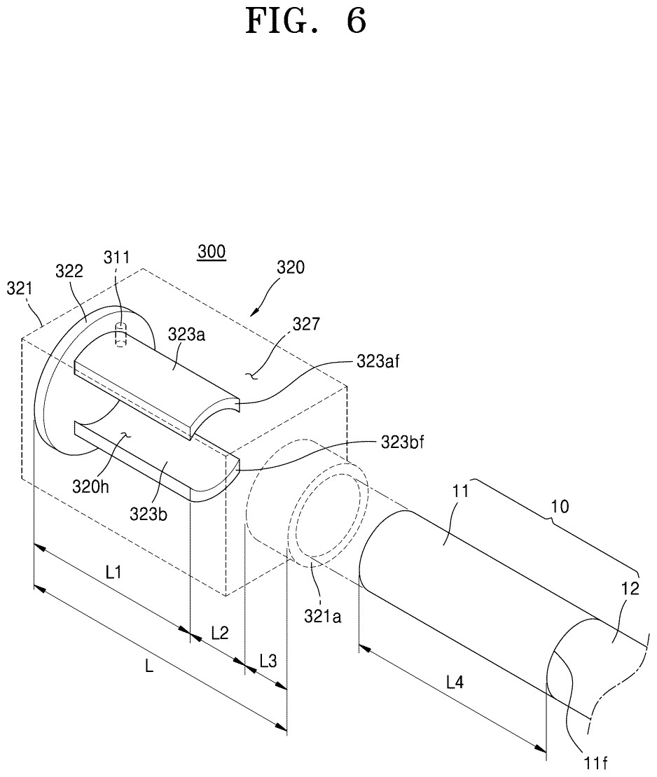

FIG. 6 is a schematic perspective view of a heater assembly according to another embodiment.

A heater assembly 300, according to the embodiment as shown in FIG. 6, may include a resonating unit 320 that generates microwave resonance and a coupler 311 that supplies microwaves to the resonating unit 320.

The resonating unit 320 may include a case 321, a plurality of plates 323a and 323b, and a connecting portion 322 that connects the case 321 to the plates 323a and 323b.

The coupler 311 may deliver microwaves to at least one of the plates 323a and 323b to generate resonance in the resonating unit 320.

The resonating unit 320 may surround at least a portion of the aerosol generating article 10 inserted into the aerosol generating device. The coupler 311 may provide the resonating unit 320 with the microwaves generated by an oscillating unit (not shown). When the microwaves are supplied to the resonating unit 320, microwave resonance occurs in the resonating unit 320 such that the resonating unit 320 may heat the aerosol generating article 10. For example, dielectrics included in the aerosol generating article 10 may be heated by the electric field generated within the resonating unit 320 due to the microwaves, and the aerosol generating article 10 may be heated by the heat generated from the dielectrics.

The case 321 of the resonating unit 320 functions as the ‘outer conductor.’ Because the case 321 has an empty hollow shape, the components of the resonating unit 320 may be arranged inside the case 321.

The case 321 may include an accommodation space 320h for accommodating the aerosol generating article 10 and an opening 321a through which the aerosol generating article 10 may be inserted. The opening 321a is connected to the accommodation space 320h. Because the opening 321a is open towards the outside of the case 321, the accommodation space 320h may be connected to the outside through the opening 321a. Therefore, the aerosol generating article 10 may be inserted into the accommodation space 320h of the case 321 through the opening 321a of the case 321.

The case 321 in the drawing has a square shape, but the shape may vary. For example, the case 321 may be modified to have various cross-sectional shapes, for example, a rectangle, an oval, or a circle. The case 321 may extend in a direction.

The plurality of plates 323a and 323b functioning as ‘inner conductors’ of the resonating unit 320 may be arranged inside the case 321.

The plates 323a and 323b may be arranged apart from each other along a circumferential direction of the aerosol generating article 10 accommodated in the accommodation space 320h. The plates 323a and 323b may include a first plate 323a arranged to surround a portion of the aerosol generating article 10 and a second plate 323b arranged to surround another portion of the aerosol generating article 10.

The plates 323a and 323b may be connected to the case 321 via the connecting portion 322. In addition, one ends of the first plate 323a of the plates 323a and 323b may be connected to one end portion of the second plate 323b via the connecting portion 322. Therefore, a closed end/short end may be formed at the one ends of the plates 323a and 323b by the connecting portion 322.

The other end 323af of the first plate 323a and the other end 323bf of the second plate 323b of the plates 323a and 323b may be spaced apart from each other and thus open. Because the other ends of the plates 323a and 323b are spaced apart from each other, an open end may be formed at the other ends of the plates 323a and 323b.

As the plates 323a and 323b are connected to the connecting portion 322, a resonator assembly may be completed. The cross-sectional shape of the resonator taken along a lengthwise direction thereof may include a horseshoe shape.

The plates 323a and 323b extend in the lengthwise direction of the aerosol generating article 10. At least a portion of the plates 323a and 323b may be curved to protrude outward from the center of the aerosol generating article 10 in the lengthwise direction thereof.

For example, when the aerosol generating article 10 has a cylindrical shape, the plates 323a and 323b may be curved in a circumferential direction along the outer circumferential surface of the aerosol generating article 10. The radius of curvature of the cross-section of the plates 323a and 323b may be identical to the radius of curvature of the aerosol generating article 10. The radius of curvature of the cross-section of the plates 323a and 323b may be variously modified. For example, the radius of curvature of the cross-section of the plates 323a and 323b may be greater or less than that of the aerosol generating article 10.

According to the structure in which the plates 323a and 323b are curved in the circumferential direction along the outer circumferential surface of the aerosol generating article 10, a more uniform electric field may be formed in the resonating unit 320, and thus, the heater assembly 300 may uniformly heat the aerosol generating article 10.

The open end at the other ends of the plates 323a and 323b may be arranged to face the opening 321a of the case 321. The opening 321a of the case 321 may be located away from the other ends of the plates 323a and 323b.

The open end at the other ends of the plates 323a and 323b may be aligned with the opening 321a of the case 321. Therefore, when the aerosol generating article 10 is inserted through the opening 321a of the case 321 and placed in the accommodation space 320h, a portion of the aerosol generating article 10 located in the accommodation space 320h may be surrounded by the plates 323a and 323b.

Two plates, that is, the plates 323a and 323b, may be arranged at opposite locations with respect to the center of the aerosol generating article 10 in the lengthwise direction thereof. One or more embodiments are not limited to the number of plates 323a and 323b, and the number of plates 323a and 323b may be, for example, three or at least four.

The plates 323a and 323b may be arranged symmetrically to each other with respect to the lengthwise direction of the aerosol generating article 10, that is, the central axis in the extension direction of the aerosol generating article 10.

At least one of the plates 323a and 323b may contact the coupler 311 connected to the oscillating unit (not shown). In detail, at least a portion of the first plate 323a may contact the coupler 311. When microwaves are delivered to the first plate 323a through the coupler 311, microwave resonance is formed between the plates 323a and 323b. Microwave resonance is also formed not only between the first plate 323a and an upper side plate of the case 321 but between the second plate 323b and a lower side plate of the case 321. Therefore, electric fields may be generated respectively between the plates 323a and 323b and the connecting portion 322, between the first plate 323a and the upper side plate of the case 321, and between the second plate 323b and the lower side plate of the case 321.

As the coupler 311 penetrates the case 321, one end of the coupler 311 may contact the oscillating unit (not shown), and the other end thereof may contact a portion of the first plate 323a. As the microwaves generated from the oscillating unit (not shown) are delivered to the plates 323a and 323b and the connecting portion 322 through the coupler 311, an electric field may be generated inside the assembly of the plates 323a and 323b and the connecting portion 322.

In addition, according to the structure of the resonating unit 320 of the heater assembly 300, a triple resonance mode may be formed in the resonating unit 320. Resonance of the transverse electric and magnetic (TEM) mode of microwaves is formed between the plates 323a and 323b. Additionally, the resonance of the TEM mode, which is different from the resonance formed between the plates 323a and 323b, is generated not only between the first plate 323a and the upper side plate of the case 321 but also between the second plate 323b and the lower side plate of the case 321. Because the resonating unit 320 of FIG. 6 may resonate in the TEM mode by using the plates 323a and 323b, the resonating unit 320 of FIG. 6 may be smaller in size than the resonating unit 220 of FIG. 5 that may only resonate in the transverse electric (TE) and transverse magnetic (TM) modes.

As triple resonance occurs in the resonating unit 320 of the heater assembly 300, the aerosol generating article 10 may be more effectively and uniformly heated.

The resonating unit 320 according to the embodiment may include a closed end/short end, in which a cross-section is closed to have a length of one quarter (λ/4) of the wavelength (λ) of the microwaves, and an open end, in which at least a portion of the cross-section is open.

A region at one end of the resonating unit 320, which corresponds to the region on the left side in FIG. 6, may form a closed end/short end due to the structure in which the connecting portion 322 and the ends of the plates 323a and 323b are connected to the case 321. A region at the other end of the resonating unit 320, which corresponds to the region on the right side in FIG. 6, forms an open end as the opening 321a of the case 321 is exposed to the outside. With the above structure of the resonating unit 320, the resonating unit 320 may function as a resonator with a length of one quarter of the wavelength of the microwaves.

According to the above-described resonance structure of the resonating unit 320, an electric field may not propagate to the outer region of the resonating unit 320. Therefore, the heater assembly 300 may prevent the electric field from leaking to the outside of the heater assembly 300 without a separate blocking member for blocking the electric field.

The aerosol generating article 10 inserted into the accommodation space 320h of the case 321 may be surrounded by the first plate 323a and the second plate 323b and thus heated using a dielectric heating method. For example, a portion including a medium of the aerosol generating article 10 inserted into the accommodation space 320h of the case 321 may be located in the space between the first plate 323a and the second plate 323b. As dielectrics included in the aerosol generating article 10 generate heat by the electric field formed in the space between the first plate 323a and the second plate 323b, the aerosol generating article 10 may be heated.

In addition, secondary heating on the aerosol generating article 10 may occur due to the action of the electric field resulting from the resonance modes respectively formed between the first plate 323a and the upper side plate of the case 321 and between the second plate 323b and the lower side plate of the case 321.

When the aerosol generating article 10 is inserted into the resonating unit 320 through the accommodation space 320h, a tobacco rod 11 of the aerosol generating article 10 may be located between the plates 323a and 323b.

A length L4 of the tobacco rod 11 may be greater than a length L1 of the plates 323a and 323b. Therefore, a front end 11f of the tobacco rod 11 contacting a filter rod 12 protrudes more in a direction towards the opening 321a of the case 321, compared to the other end 323af of the first plate 323a and the other end 323bf of the second plate 323b.

Resonance peaks are formed at the other ends of the plates 323a and 323b operating as the resonators, generating a stronger electric field at the other ends than in other regions. When the aerosol generating article 10 is inserted into the heater assembly 300, the tobacco rod 11 including the dielectrics capable of generating heat from the electric field is arranged to correspond to the region where the electric field is the strongest, and thus the heating efficiency (or the ‘dielectric heating efficiency’) of the heater assembly 300 may be improved.

Referring to FIG. 6, the length L1 of the plates 323a and 323b may be set to be less than the length L1+L2 of the inner space of the case 321. Therefore, the other ends of the plates 323a and 323b may be arranged on the inner side of the case 321 compared to the opening 321a. In other words, the other ends of the plates 323a and 323b may be spaced apart from a rear end portion of the opening 321a by a length of L2.

The length from the rear end of the opening 321a, where the opening 321a is connected to the case 321, to the front end of the opening 321a, where the opening 321a is open, may be L3. The total length of the case 321 along the lengthwise direction of the case 321 may be L. The total length L of the case 321 may be determined by the sum of the length L1 of the plates 323a and 323b, the length L2 between the plates 323a and 323b and the rear end of the opening 321a, and the length L3 where the opening 321a protrudes from the case 321.

To prevent the microwave leakage, the front end of the opening 321a, where the opening 321a is open, protrudes from the case 321 by a length of L3. As the opening 321a of the case 321 protrudes from the case 321, the opening 321a may prevent the microwaves in the case 321 of the resonating unit 320 from leaking to the outside of the case 321.

The resonating unit 320 may further include a dielectric accommodation space 327 for accommodating dielectrics. The dielectric accommodation space 327 may be formed in the empty space between the case 321 and the plates 323a and 323b. In the dielectric accommodation space 327, dielectrics with low microwave absorption may be accommodated.

As the dielectrics are arranged within the dielectric accommodation space 327, an electric field, which is similar to an electric field produced by a resonating unit with no dielectrics, may be generated while reducing the overall size of the resonating unit 320. In other words, the mounting space for the resonating unit 320 in the aerosol generating device may decrease by reducing the size of the resonating unit 320 by using the dielectrics arranged within the dielectric accommodation space 327, leading to the miniaturization of the aerosol generating device.

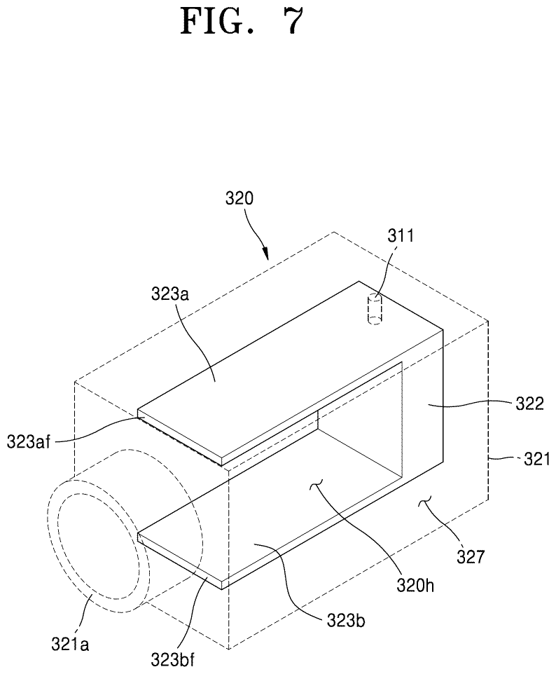

FIG. 7 is a schematic perspective view of a heater assembly according to another embodiment.

The heater assembly according to the embodiment of FIG. 7 may include a resonating unit 320 that generates microwave resonance and a coupler 311 that supplies microwaves to the resonating unit 320.

The case 321 of the resonating unit 320 may include an accommodation space 320h for accommodating the aerosol generating article and an opening 321a through which the aerosol generating article may be inserted.

Ends of the plates 323a and 323b of the resonating unit 320 may be connected to the connecting portion 322. The plates 323a and 323b may be connected to the case 321 via the connecting portion 322. Other ends of the plates 323a and 323b may be open towards the opening 321a of the case 321.

The case 321 of the resonating unit 320, the plates 323a and 323b, and the connecting portion 322 may each include a metal material.

The plates 323a and 323b may be arranged apart from each other along a circumferential direction of the aerosol generating article accommodated in the accommodation space 320h. The plates 323a and 323b may include a first plate 323a arranged to surround a portion of the aerosol generating article and a second plate 323b arranged to surround another portion of the aerosol generating article.

The description ‘a plurality of plates are spaced apart from each other in the circumferential direction of the aerosol generating article’ may suggest that the plurality of plates are placed at different locations along the circumferential direction of the aerosol generating article.

Additionally, the description ‘a plurality of plates are spaced apart from each other in the circumferential direction of the aerosol generating article’ may indicate that the plurality of plates may be arranged at different locations along the circumferential direction with respect to the ‘lengthwise direction’ in which the heater assembly or the aerosol generating device extends.

The description ‘a plurality of plates surround some portions of the aerosol generating article’ may imply that the plurality of plates extend in the circumferential direction of an outer surface of the aerosol generating article and are arranged to face the outer surface of the aerosol generating article. The plates may simply have a planar shape and surround some portions of the outer surface of the aerosol generating article. As another example, the plates may surround some portions of the outer surface of the aerosol generating article while taking a bent or curved shape to correspond to the cross-sectional shape of the aerosol generating article.

The first plate 323a and the second plate 323b may be respectively arranged on an upper portion and a lower portion of the accommodation space 320h and face each other. Each of the first plate 323a and the second plate 323b may extend in the direction, into which the aerosol generating article is inserted, and include a thin and flat rectangular plate.

The shape of each of the first plate 323a and the second plate 323b may be modified in various ways. For example, each of the plates 323a and 323b may be changed to have a square plate, a polygonal plate, a circular plate, or an oval plate.

The plates 323a and 323b may be connected to the case 321 via the connecting portion 322. In addition, one end of the first plate 323a of the plates 323a and 323b may be connected to one end of the second plate 323b via the connecting portion 322. Therefore, a closed end/short end may be formed at the ends of the plates 323a and 323b by the connecting portion 322.

The other end 323af of the first plate 323a of the plates 323a and 323b and the other end 323bf of the second plate 323b may be spaced apart from each other and thus open. Because other ends of the plates 323a and 323b are spaced apart from each other, an open end may be formed at the other ends of the plates 323a and 323b.

The accommodation space 320h between the first plate 323a and the second plate 323b is open in the inner space of the case 321 due to side surfaces of the first plate 323a and the second plate 323b.

The open end at the other ends of the plates 323a and 323b may face the opening 321a of the case 321. The opening 321a of the case 321 may be arranged away from the other ends of the plates 323a and 323b. The opening 321 protruding from the case 321 may prevent the microwaves in the case 321 from leaking to the outside of the case 321.

The open end at the other ends of the plates 323a and 323b may be aligned with the opening 321a of the case 321. Therefore, when the aerosol generating article is inserted through the opening 321a of the case 321 and placed in the accommodation space 320h, a portion of the aerosol generating article located in the accommodation space 320h may be surrounded by the plates 323a and 323b.

When the microwaves are delivered to the resonating unit 320 through the coupler 311, microwave resonance occurs in the resonating unit 320, and thus, the resonating unit 320 may heat the aerosol generating article inserted between the plates 323a and 323b.

The dielectric accommodation space 327 may be formed between the case 321 and each of the plates 323a and 323b. The dielectric accommodation space 327 may be empty. Alternatively, dielectrics with low microwave absorption may be accommodated in the dielectric accommodation space 327.

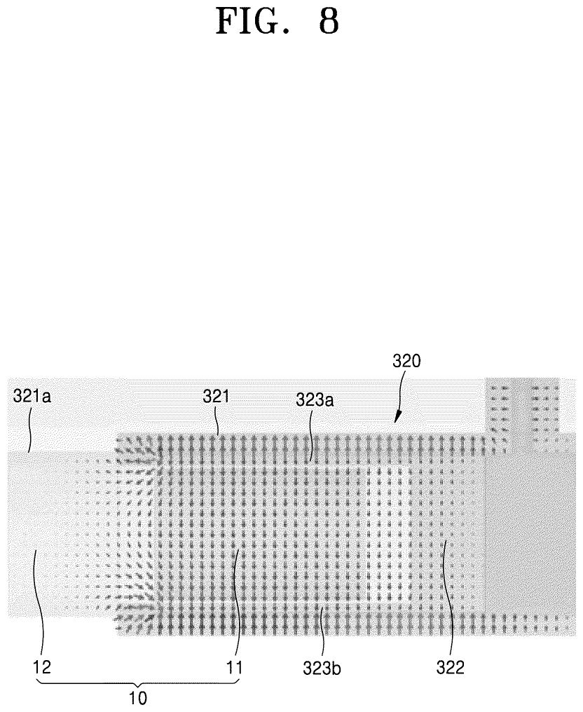

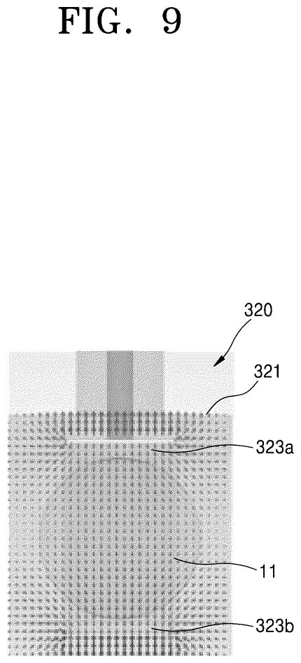

FIG. 8 is a side view schematically showing the electric field distribution of the heater assembly of FIG. 7, and FIG. 9 is a front view schematically showing the electric field distribution of the heater assembly of FIG. 7. The electric field distributions of FIGS. 8 and 9 represent the intensity of voltages (V/m) per unit length of the resonating unit.

A region at one end of the resonating unit 320, which corresponds to the region on the right side in FIG. 8, forms a closed end/short end because of the structure in which the connecting portion 322 and the ends of the plates 323a and 323b are connected to the case 321. The other ends of the plates 323a and 323b of the resonating unit 320, which correspond to the left side in FIG. 8, form an open end. With the above structure of the resonating unit 320, the resonating unit 320 may function as a resonator with a length of one quarter of the wavelength of the microwaves.

A strong electric field may be generated at portions corresponding to the open end of the other ends of the plates 323a and 323b of the resonating unit 320. Resonance peaks are formed at the other ends of the plates 323a and 323b, generating a stronger electric field than in other regions. When the aerosol generating article 10 is inserted into the heater assembly 300, the tobacco rod 11 including the dielectrics capable of generating heat from the electric field is arranged to correspond to the region where the electric field is the strongest, and thus the heating efficiency (or the ‘dielectric heating efficiency’) of heating the aerosol generating article 10 may be improved.

According to the structure of the resonating unit 320 of the heater assembly, a triple resonance mode may be formed in the resonating unit 320. Resonance of the TEM mode of microwaves is formed between the plates 323a and 323b. Additionally, the resonance of the TEM mode, which is different from the resonance formed between the plates 323a and 323b, is generated not only between the first plate 323a and the upper side plate of the case 321 but also between the second plate 323b and the lower side plate of the case 321.

As triple resonance occurs in the resonating unit 320 of the heater assembly, the aerosol generating article may be more effectively and uniformly heated. Because of the triple resonance occurring in the resonating unit 320 of the heater assembly, heating patterns are symmetrically formed with respect to the tobacco rod 11 of the aerosol generating article. Therefore, the tobacco rod 11 may be gradually consumed by the heater assembly in the radial direction towards the outer side from the center of the tobacco rod.

Additionally, the opening 321a protruding from the case 321 may prevent the microwaves in the case 321 from leaking to the outside of the case 321 and being delivered to the user.

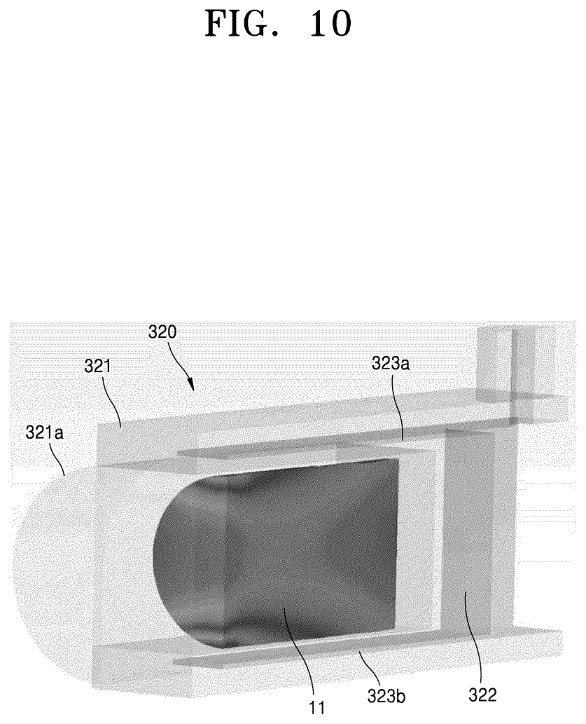

FIG. 10 is a perspective view schematically showing the heating density distribution of the aerosol generating article heated by the heater assembly of FIG. 7. The heating density distribution of FIG. 10 indicates temperature energy (W/m³) per unit volume in each region of the heated aerosol generating article.

A strong electric field may be generated at the portions corresponding to the open end of the other ends of the plates 323a and 323b of the resonating unit 320. Resonance peaks are formed at the other ends of the plates 323a and 323b, generating stronger electric field than in other regions. The electric field at the portions corresponding to the closed end/short end of the resonating unit 320 may be zero. Because the tobacco rod 11 including the dielectrics, which may generate heat by the electric field of the aerosol generating article, is arranged to correspond to the region where the electric field is the strongest in the resonating unit 320, the portion of the resonating unit 320 corresponding to the tobacco rod 11 may be heated to the highest temperature.

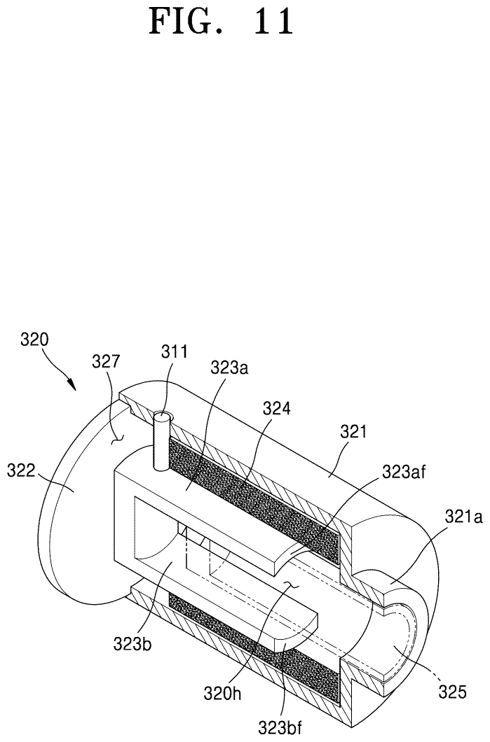

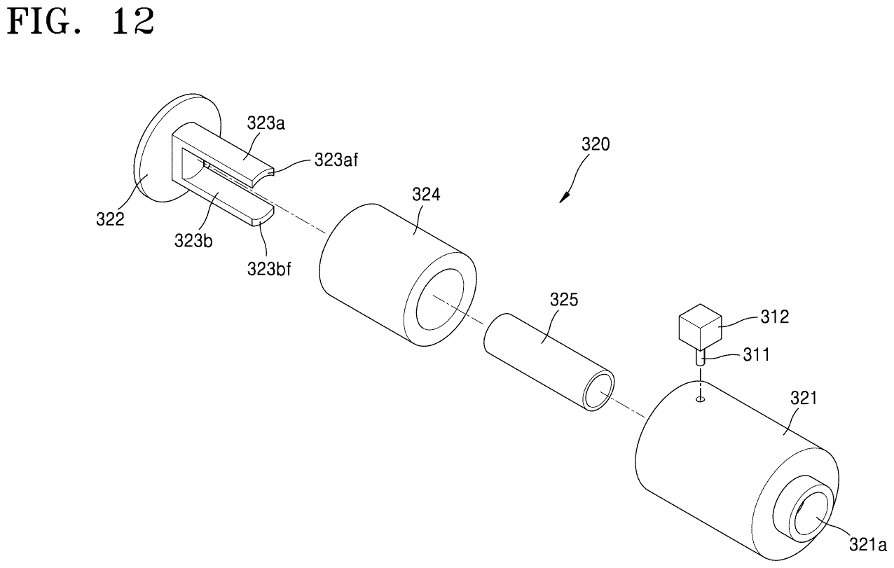

FIG. 11 is a schematic perspective view of a partially cutaway portion of a heater assembly according to another embodiment, and FIG. 12 is an exploded perspective view schematically showing components of the heater assembly of FIG. 11.

The heater assembly according to the embodiments of FIGS. 11 and 12 may include a resonating unit 320 that generates microwave resonance and a coupler 311 that supplies microwaves to the resonating unit 320.

The case 321 of the resonating unit 320 may include an accommodation space 320h for accommodating the aerosol generating article and an opening 321a through which the aerosol generating article may be inserted. The case 321 may have a cylindrical hollow shape extending in the lengthwise direction into which the aerosol generating article is inserted.

Ends of the plates 323a and 323b of the resonating unit 320 may be connected to the case 321 via the connecting portion 322. The other ends of the plates 323a and 323b may be open towards the opening 321a of the case 321.

The plates 323a and 323b may include a first plate 323a and a second plate 323b that are arranged apart from each other in the circumferential direction of the aerosol generating article accommodated in the accommodation space 320h.

The plates 323a and 323b extend in the lengthwise direction of the case 321. At least a portion of the plates 323a and 323b may be curved to protrude outward from the center of the accommodation space 320h, in which the aerosol generating article is accommodated, in the lengthwise direction of the accommodation space 320h. The first plate 323a may be curved and extend in the circumferential direction of the aerosol generating article to surround a portion of the aerosol generating article. The second plate 323b may be curved and extend in the circumferential direction of the aerosol generating article to surround another portion of the aerosol generating article.

The other end 323af of the first plate 323a of the plates 323a and 323b and the other end 323bf of the second plate 323b may be spaced apart from each other and thus open. Because the other ends of the plates 323a and 323b are spaced apart from each other, an open end may be formed at the other ends of the plates 323a and 323b.

The open end at the other ends of the plates 323a and 323b may face the opening 321a of the case 321. The opening 321a of the case 321 may be arranged away from the other ends of the plates 323a and 323b.

The resonating unit 320 may include a dielectric accommodation space 327 for accommodating the dielectrics. The dielectric accommodation space 327 may be formed in the empty space between the case 321 and the plates 323a and 323b. In the dielectric accommodation space 327, dielectrics 324 with low microwave absorption may be accommodated.

The dielectrics 324 may include a cylindrical hollow therein. In the empty space in the dielectrics 324, the plates 323a and 323b may be inserted. The dielectrics 324 and the plates 323a and 323b may be mounted into the case 321. The dielectrics 324 may protrude further than the other ends of the plates 323a and 323b towards the opening 321a in the lengthwise direction in which the case 321 extends.

As the dielectrics 324 are arranged within the dielectric accommodation space 327 of the resonating unit 320, an electric field, which is similar to an electric field produced by a resonating unit with no dielectrics, may be generated while reducing the overall size of the resonating unit 320. That is, the size of the resonating unit 320 may be reduced using the dielectrics 324 arranged in the dielectric accommodation space 327. As the dielectrics 324 are arranged in the dielectric accommodation space 327, the thickness of the resonating unit 320 may be reduced, and thus, the total outer diameter of the resonating unit 320 may decrease. To this end, the mounting space for the resonating unit 320 in the aerosol generating device may be reduced, and the aerosol generating device may become compact accordingly.

The term ‘mounting space’ may refer to an area of the aerosol generating device where various components may be installed.

A support tube 325 may be arranged inside the plates 323a and 323b. The support tube 325 may include a cylindrical hollow with one end closed and the other end open. The aerosol generating article may be inserted into the support tube 325. As the support tube 325 is arranged between the plates 323a and 323b, the aerosol generating article inserted into the heater assembly may be maintained between the plates 323a and 323b. A closed surface at one end of the support tube 325 may contact an end of the aerosol generating article inserted into the support tube 325 and support the aerosol generating article.

The support tube 325 may include a resin material with a waterproof function and/or an insulating function and may include, for example, polytetrafluoroethylene (PTFE).

The support tube 325 may prevent droplets, which are generated as aerosols are re-liquefied, or moisture generated from the aerosol generating article from leaking to the outside of the support tube 325. In addition, the support tube 325 may prevent heat, which is generated at the location of the aerosol generating article, from escaping to the outside of the support tube 325. The support tube 325 may perform an anti-leaking function to prevent liquid leakage to other structures of the resonating unit 320 as well as an insulation function to prevent heat loss.

The resonating unit 320 may include an air introduction path through which external air may be introduced. The air introduction path may be formed in the support tube 325 or between the support tube 325 and the case 321. When the user holds the aerosol generating article 10 in their mouth and inhales, external air may be introduced into the resonating unit 320 through the air introduction path. Air is introduced into the aerosol generating article 10 through the end of the aerosol generating article 10. The air may flow through the aerosol generating article 10 and may be delivered to the user along with the aerosol generated in the aerosol generating article 10.

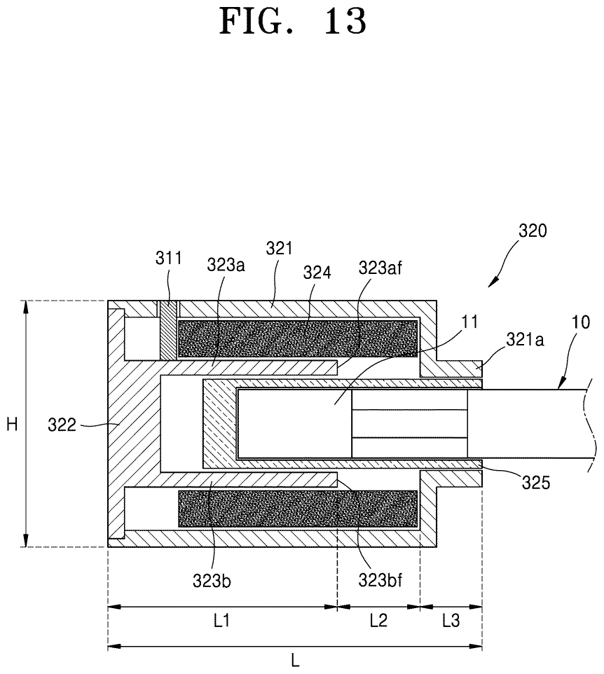

FIG. 13 is a cross-sectional view of the heater assembly of FIG. 11.

When the aerosol generating article 10 is inserted into the support tube 325 of the resonating unit 320, the tobacco rod 11 of the aerosol generating article 10 may be arranged between the plates 323a and 323b. Because a closed surface at one end of the support tube 325 supports the left-side end of the tobacco rod 11, the movement of the aerosol generating article 10 towards the left side may be restricted.

A front end of the tobacco rod 11 contacting a filter rod protrudes further in the direction towards the opening 321a of the case 321, compared to the other end 323af of the first plate 323a and the other end 323bf of the second plate 323b.

The length L1 of the plates 323a and 323b may be set to be less than the length L1+L2 of the inner space of the case 321. Therefore, the other ends of the plates 323a and 323b may be arranged on the inner side of the case 321 compared to the opening 321a. In other words, the other ends of the plates 323a and 323b may be spaced apart from the rear end portion of the opening 321a by a length of L2.

The length of the opening 321a protruding from the case 321 may be L3. The total length of the case 321 along the lengthwise direction of the case 321 may be L. The total length L of the case 321 may be determined in a range from about 25 mm to about 35 mm, and the total length L of the case 321 of FIG. 13 may be about 29 mm. To prevent the microwave leakage, the length L3 of the opening 321a may be at least 5 mm.

The height H of the case 321 in the direction crossing the lengthwise direction of the case 321 may be determined within a range from about 13 mm to about 25 mm, and the height H of the case 321 of FIG. 13 is about 16 mm.

The front end of the dielectric 324 arranged within the resonating unit 320 may protrude further than the other ends of the plates 323a and 323b in the lengthwise direction of the case 321. Referring to FIG. 13, the front end of the dielectric 324 may contact the inner surface of the case 321. The length L2, where the front end of the dielectric 324 protrudes further than the other ends of the plates 323a and 323b, may vary. Therefore, the front end of the dielectric 324 may be spaced apart from the inner surface of the case 321 such that the front end of the dielectric 324 protrudes further than the other ends of the plates 323a and 323b but is not in contact with the inner surface of the case 321.

At least a portion of the first plate 323a of the plates 323a and 323b may contact the coupler 311. The location where the coupler 311 contacts the first plate 323a may be determined to be closer to the connecting portion 322 than to the opening 321a in the section from the opening 321a to the connecting portion 322.

When microwaves are delivered to the first plate 323a through the coupler 311, microwave resonance is formed between the plates 323a and 323b. In addition, microwave resonance is formed not only between the first plate 323a and an upper side plate of the case 321 but between the second plate 323b and a lower side plate of the case 321. Therefore, electric fields may be generated respectively between the plates 323a and 323b and the connecting portion 322, between the first plate 323a and the upper side plate of the case 321, and between the second plate 323b and the lower side plate of the case 321.

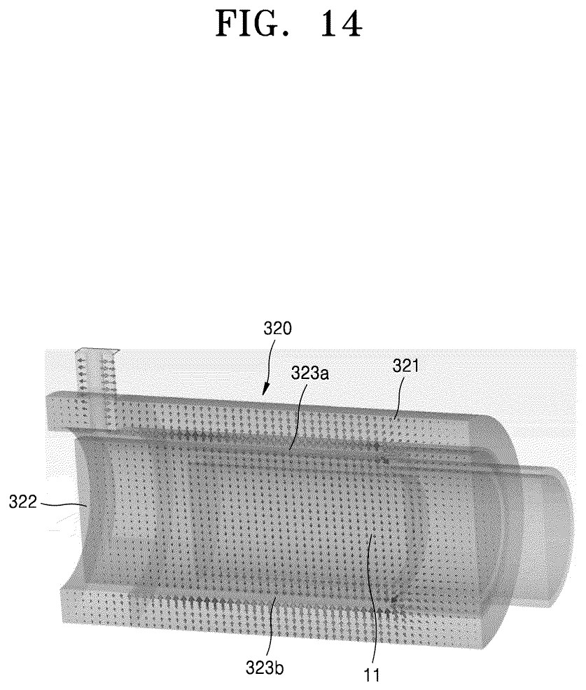

FIG. 14 is a perspective view schematically showing the electric field distribution of the heater assembly of FIG. 11. The electric field distribution of FIG. 14 represents the intensity of voltages (V/m) per unit length of the resonating unit.

Based on the structure of the resonating unit 320 of the heater assembly, a triple resonance mode may be formed in the resonating unit 320. Resonance of the TEM mode of microwaves is formed between the plates 323a and 323b. Additionally, the resonance of the TEM mode, which is different from the resonance formed between the plates 323a and 323b, is generated not only between the first plate 323a and the upper side plate of the case 321 but also between the second plate 323b and the lower side plate of the case 321.

As triple resonance occurs in the resonating unit 320 of the heater assembly, the aerosol generating article may be more effectively and uniformly heated.

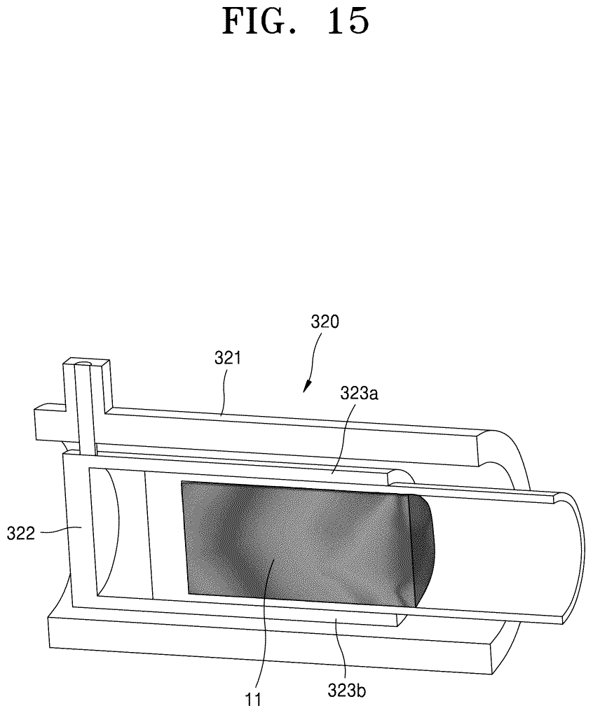

FIG. 15 is a perspective view schematically showing the heating density distribution of the aerosol generating article heated by the heater assembly of FIG. 11. The heating density distribution of FIG. 15 indicates temperature energy (W/m³) per unit volume in each region of the heated aerosol generating article.

A strong electric field may be generated at the portions corresponding to the open end of the other ends of the plates 323a and 323b of the resonating unit 320. Resonance peaks are formed at the other ends of the plates 323a and 323b, generating a stronger electric field than in other regions. The electric field at the portions corresponding to the closed end/short end of the resonating unit 320 may be zero. Because the tobacco rod 11 including the dielectrics, which may generate heat by the electric field of the aerosol generating article, is arranged to correspond to the region where the electric field is the strongest in the resonating unit 320, the portion of the resonating unit 320 corresponding to the tobacco rod 11 may be heated to the highest temperature.

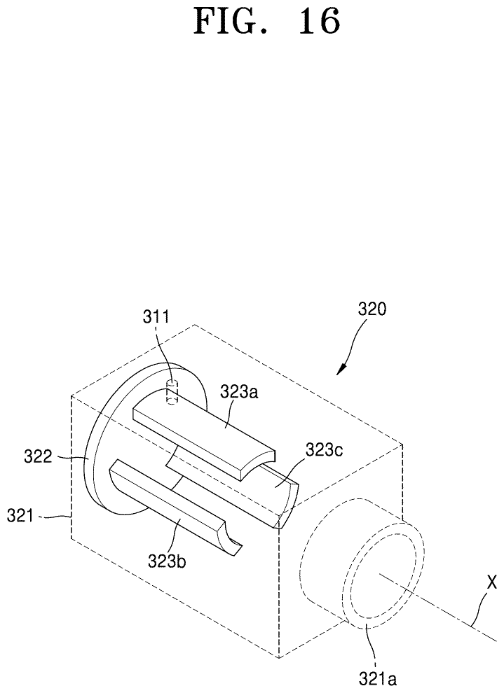

FIG. 16 is a schematic perspective view of a heater assembly according to another embodiment.

The heater assembly according to the embodiment of FIG. 16 may include a resonating unit 320 that generates microwave resonance and a coupler 311 that supplies microwaves to the resonating unit 320.

The case 321 of the resonating unit 320 may include an accommodation space configured to accommodate the aerosol generating article and an opening 321a through which the aerosol generating article may be inserted. The case 321 may have a hollow tubular shape extending in the lengthwise direction into which the aerosol generating article is inserted.

The plurality of plates of the resonating unit 320 may include a first plate 323a, a second plate 323b, and a third plate 323c which are arranged apart from each other in the circumferential direction of the aerosol generating article accommodated in the accommodation space 320h.

Three plates are spaced apart from each other in the circumferential direction with respect to the center axis X of the lengthwise direction of the aerosol generating article accommodated in the case 321. The plurality of plates may be arranged apart from each other in the circumferential direction with respect to the lengthwise direction of the case 321 along which the case 321 extends. One or more embodiments are not limited to the number of plates, and the number of plates may be, for example, at least four.

Because one end of each of the first plate 323a, the second plate 323b, and the third plate 323c is connected to the case 321 via the connecting portion 322, a closed end/short end may be formed on the side of the connecting portion 322. As the first plate 323a, the second plate 323b, and the third plate 323c are connected to the connecting portion 322, a resonator assembly may be completed.

Because the other ends of the first plate 323a, the second plate 323b, and the third plate 323c are spaced apart from each other and open towards the opening 321a of the case 321, an open end may be formed at the other ends of the first plate 323a, the second plate 323b, and the third plate 323c.

The plurality of plates may extend in the lengthwise direction of the case 321. At least a portion of the plates may be curved to protrude outward from the center of the accommodation space 320h, in which the aerosol generating article is accommodated, in the lengthwise direction of the accommodation space 320h. Each of the first plate 323a, the second plate 323b, and the third plate 323c may be curved and extend in the circumferential direction of the aerosol generating article to surround different portions of the aerosol generating article.

According to the structure in which the plates are curved in the circumferential direction along the outer circumferential surface of the aerosol generating article, a more uniform electric field may be formed in the resonating unit 320, and thus, the heater assembly may uniformly heat the aerosol generating article.

Although embodiments have been described in which each plate is curved in the circumferential direction along the outer circumferential surface of the aerosol generating article and thus has a circular arc-shaped cross-section, the shape in which each plate is curved may vary. For example, each plate may have a generally flat plate shape, but a curved surface that is curved along the circumferential direction of the aerosol generating article may be formed so that the inner surface of each plate, which faces the outer circumferential surface of the aerosol generating article, corresponds to the outer circumferential surface.

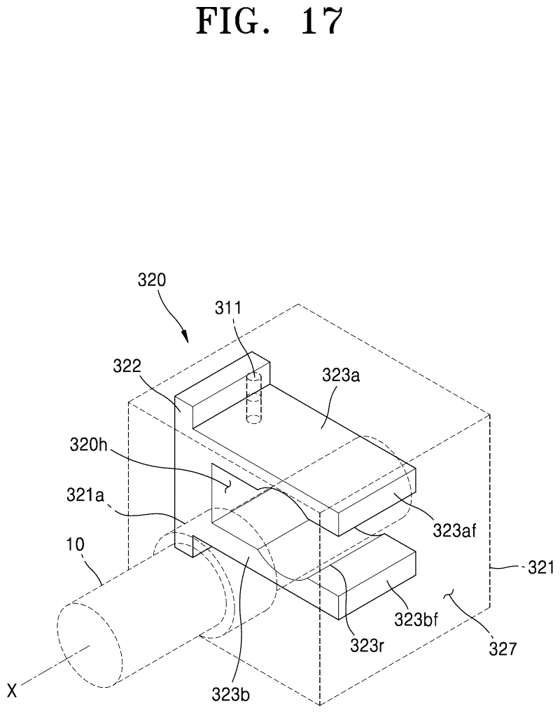

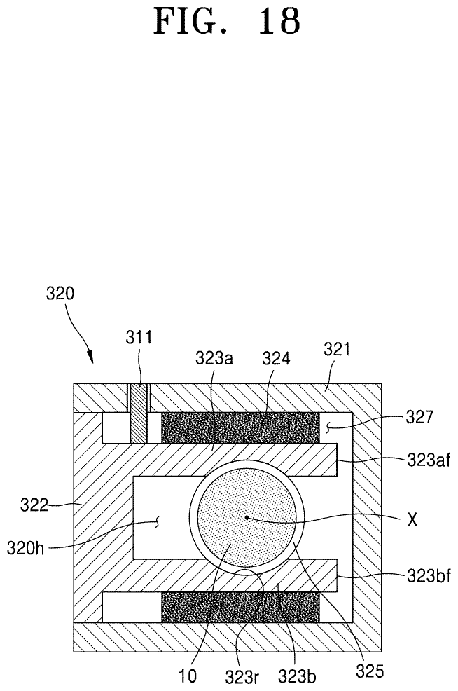

FIG. 17 is a schematic perspective view of a heater assembly according to another embodiment, and FIG. 18 is a cross-sectional view of the heater assembly of FIG. 17.

The heater assembly according to the embodiments of FIGS. 17 and 18 may include a resonating unit 320 that generates microwave resonance and a coupler 311 that provides microwaves to the resonating unit 320.

The case 321 of the resonating unit 320 may include an accommodation space 320h for accommodating an aerosol generating article 10 and an opening 321a through which the aerosol generating article may be inserted.

Ends of the plates 323a and 323b of the resonating unit 320 may be connected to the connecting portion 322. The plates 323a and 323b may be connected to the case 321 via the connecting portion 322. The other ends of the plates 323a and 323b may be open in the inner space of the case 321.

The plates 323a and 323b may be located at opposite locations with respect to the aerosol generating article 10 accommodated in the accommodation space 320h. The plates 323a and 323b may include a first plate 323a arranged to surround a portion of the aerosol generating article 10 and a second plate 323b arranged to surround another portion of the aerosol generating article 10.

The first plate 323a and the second plate 323b may be respectively arranged on an upper portion and a lower portion of the accommodation space 320h and face each other. Each of the first plate 323a and the second plate 323b may extend in a direction crossing the central axis X of the direction in which the aerosol generating article 10 extends. The direction in which each of the first plate 323a and the second plate 323b extends may be substantially perpendicular to the direction in which the aerosol generating article 10 extends.

Each of the first plate 323a and the second plate 323b may have a thin and flat rectangular plate shape. In addition, each of the first plate 323a and the second plate 323b may include a concave surface 323r that is concavely formed on the surface of each of the first plate 323a and the second plate 323b facing the aerosol generating article 10 at the location where the aerosol generating article 10 is accommodated.

The other end 323af of the first plate 323a of the plates 323a and 323b and the other end 323bf of the second plate 323b may be spaced apart from each other and thus open. Because other ends of the plates 323a and 323b are spaced apart from each other, an open end at the other ends of the plates 323a and 323b may be formed. The direction in which the other ends of the plates 323a and 323b open may intersect with the direction (the X-axis direction) in which the opening 321a of the case 321 opens.

Referring to FIG. 18, a dielectric accommodation space 327 is formed between the case 321 and each of the plates 323a and 323b. In the dielectric accommodation space 327, dielectrics 324 with low microwave absorption may be accommodated.

Also, a support tube 325 may be arranged inside the plates 323a and 323b. The support tube 325 may have a cylindrical hollow shape with one end closed and the other end open. The aerosol generating article 10 may be inserted into the support tube 325.

To avoid complexity, the support tube 325 and the dielectrics 324 are omitted in FIG. 17.

The support tube 325 may be mounted in the concave surfaces 323r of the plates 323a and 323b. Because the support tube 325 is fixed between the plates 323a and 323b, the support tube 325 may support the aerosol generating article 10 between the plates 323a and 323b.

In FIGS. 17 and 18, the concave surfaces 323r of the plates 323a and 323b are spaced apart in the direction towards the connecting portion 322 from the other ends of the plates 323a and 323b. The positions of the concave surface 323r may vary; for example, the concave surfaces 323r may be located at the other ends of the plates 323a and 323b. When the concave surfaces 323r are located at the other ends of the plates 323a and 323b, the aerosol generating article 10 may be mounted on the ends of the plates 323a and 323b.

When the microwaves are delivered to the resonating unit 320 through the coupler 311, microwave resonance occurs in the resonating unit 320, and thus, the resonating unit 320 may heat the aerosol generating article 10 inserted between the plates 323a and 323b.

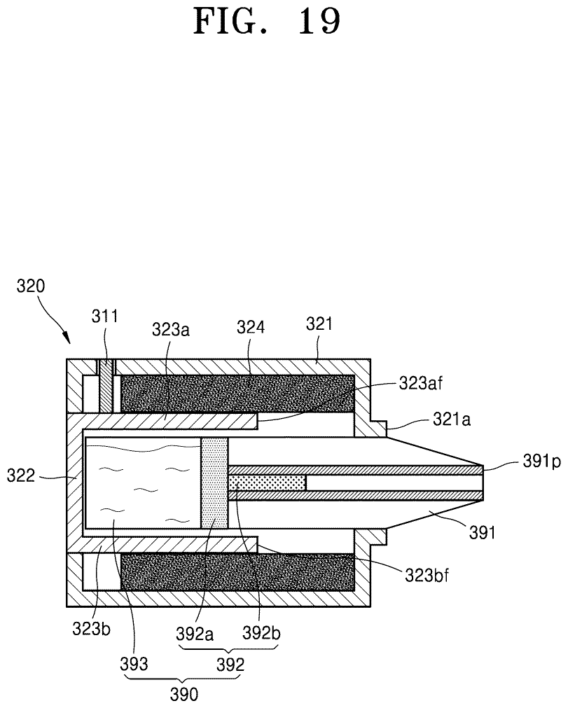

FIG. 19 is a schematic cross-sectional view of a heater assembly according to another embodiment.

An aerosol generating article that may be heated by the heater assembly of FIG. 19 may be realized as a cartridge 390. The heater assembly may include a resonating unit 320 that generates microwave resonance, and a coupler 311 that provides microwaves to the resonating unit 320.

The case 321 of the resonating unit 320 may include an accommodation space configured to accommodate an aerosol generating article and an opening 321a through which the aerosol generating article may be inserted.

Ends of the plates 323a and 323b of the resonating unit 320 may be connected to the case 321 by the connecting portion 322. The other ends of the plates 323a and 323b may be open towards the opening 321a of the case 321.

The plates 323a and 323b of the resonating unit 320 may include a first plate 323a and a second plate 323b that are spaced apart from each other in the circumferential direction of the cartridge 390 accommodated in the accommodation space. The plates 323a and 323b may be symmetrically arranged with respect to the central axis of the cartridge 390 in the lengthwise direction thereof. Referring to FIG. 19, two plates, that is, the plates 323a and 323b, are arranged at opposite positions with respect to the central axis of the cartridge 390 in the lengthwise direction thereof.

In the empty space between the case 321 of the resonating unit 320 and the plates 323a and 323b, dielectrics 324 with low microwave absorption may be accommodated.

The aerosol generating article accommodated between the plates 323a and 323b may be implemented as the cartridge 390. The cartridge 390 may include a storage 393 for storing an aerosol generating material and a generator 392 for generating an aerosol from the aerosol generating material stored in the storage 393.

The generator 392 may include an absorption portion 392a that absorbs the aerosol generating material from the storage 393, and a generating portion 392b that generates an aerosol by heating the aerosol generating material provided from the absorption portion 392a. A mouthpiece 391, which includes a discharge passage 391p for discharging the aerosol, is connected to the generator 392 of the cartridge 390.

The cartridge 390 may contain an aerosol generating material in any one of various states, such as a liquid state, a solid state, a gaseous state, a gel state, or a combination thereof. For example, the aerosol generating material may include a liquid composition. The liquid composition may be a liquid including a tobacco-containing material having a volatile tobacco flavor component, or a liquid including a non-tobacco material.

The cartridge 390 may be operated in response to an electrical signal or a wireless signal transmitted from a main body of the aerosol generating device to perform a function of generating an aerosol by converting the phase of the aerosol generating material in the cartridge 390 into a gaseous phase. The aerosols may refer to a gas in which vaporized particles generated from the aerosol generating material are mixed with air.

The absorption portion 392a and/or the generating portion 392b may include wicks such as cotton fiber, ceramic fiber, glass fiber, and porous ceramic.

At least a portion of the first plate 323a of the plates 323a and 323b may contact the coupler 311. When microwaves are delivered to the first plate 323a through the coupler 311, microwave resonance is formed between the plates 323a and 323b. In addition, microwave resonance is formed not only between the first plate 323a and an upper side plate of the case 321 but also between the second plate 323b and a lower side plate of the case 321. Therefore, electric fields may be generated respectively between the plates 323a and 323b and the connecting portion 322, between the first plate 323a and the upper side plate of the case 321, and between the second plate 323b and the lower side plate of the case 321.

The front end of the generating portion 392b of the cartridge 390 is positioned such that the front end protrudes further than the other end 323af of the first plate 323a and the other end 323bf of the second plate 323b in the direction towards the opening 321a of the case 321.

The cartridge 390 inserted into the accommodation space 320h of the case 321 may be surrounded by the first plate 323a and the second plate 323b and heated using a dielectric heating method. By the electric field generated in the space between the first plate 323a and the second plate 323b, the dielectrics of the aerosol generating material included in the generating portion 392b of the cartridge 390 generate heat such that the aerosol generating material may be heated.

The aerosol generated by heating the aerosol generating material in the generating portion 392b may be delivered to the user through the discharge passage 391p of the mouthpiece 391.

Resonance peaks may be formed at the other ends of the plates 323a and 323b functioning as the resonators, generating a stronger electric field at the other ends compared to other portions. When the cartridge 390 is inserted into the resonating unit 320, the generating portion 392b may be arranged to correspond to the region where the electric field is the strongest, thereby improving the heating efficiency (or ‘dielectric heating efficiency) of heating the generating portion 392b of the cartridge 390.

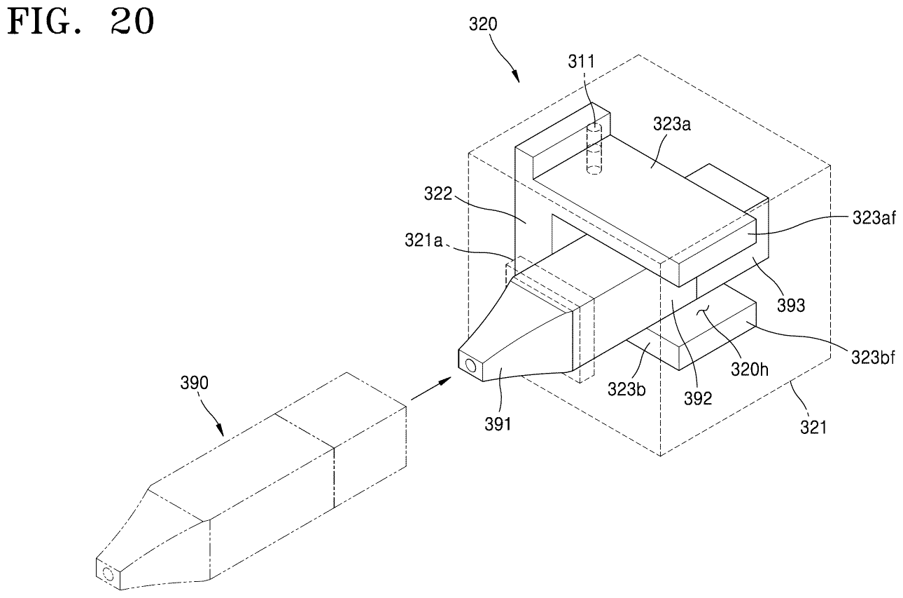

FIG. 20 is a schematic perspective view of a heater assembly according to another embodiment.

Compared to the heater assembly of FIG. 19, in the heater assembly of FIG. 20, the direction in which the cartridge 390 is mounted on the resonating unit 320 has changed.

The heater assembly according to the embodiment of FIG. 20 may include a resonating unit 320 that generates microwave resonance and a coupler 311 that provides microwaves to the resonating unit 320.

The case 321 of the resonating unit 320 may include an accommodation space 320h for accommodating the cartridge 390 that is an aerosol generating article, and an opening 321a through which the cartridge 390 may be inserted.

The cartridge 390 may include a storage 393 for storing the aerosol generating material, a generator 392 for generating an aerosol from the aerosol generating material stored in the storage 393, and a mouthpiece 391 for discharging the aerosol, which is generated by the generator 392, to the outside.

The ends of the plates 323a and 323b of the resonating unit 320 may be connected to the case 321 via the connecting portion 322. The other ends of the plates 323a and 323b may be open in the inner space of the case 321.

The plates 323a and 323b of the resonating unit 320 may include a first plate 323a and a second plate 323b that are spaced apart from each other in the circumferential direction of the cartridge 390 accommodated in an accommodation space 320h. The first plate 323a is arranged to surround a portion of the cartridge 390. The second plate 323b is arranged to surround another portion of the cartridge 390.

The first plate 323a and the second plate 323b may be respectively arranged on an upper portion and a lower portion of the accommodation space 320h and face each other. Each of the first plate 323a and the second plate 323b may extend in the direction crossing the extension direction of the cartridge 390.

The other end 323af of the first plate 323a of the plates 323a and 323b and the other end 323bf of the second plate 323b may be spaced apart from each other and thus open. Because other ends of the plates 323a and 323b are spaced apart from each other, an open end may be formed at the other ends of the plates 323a and 323b. The direction in which the other ends of the plates 323a and 323b are open may intersect with the direction in which the opening 321a of the case 321 is open.

Referring to FIG. 20, the location, at which the generator 392 of the cartridge 390 is arranged between the plates 323a and 323b, is spaced apart from the other ends of the plates 323a and 323b in the direction towards the connecting portion 322.

The location at which the generator 392 of the cartridge 390 is arranged between the plates 323a and 323b may vary; for example, the generator 392 of the cartridge 390 may be positioned to correspond to the other ends of the plates 323a and 323b.

Resonance peaks may be formed near the other ends of the plates 323a and 323b functioning as the resonators, resulting in the generation of a stronger electric field at the other ends compared to other portions. When the cartridge 390 is inserted into the resonating unit 320, the generator 392 may be arranged to correspond to the region where the electric field is the strongest, thereby improving the heating efficiency (or ‘dielectric heating efficiency) of heating the generator 392 of the cartridge 390.

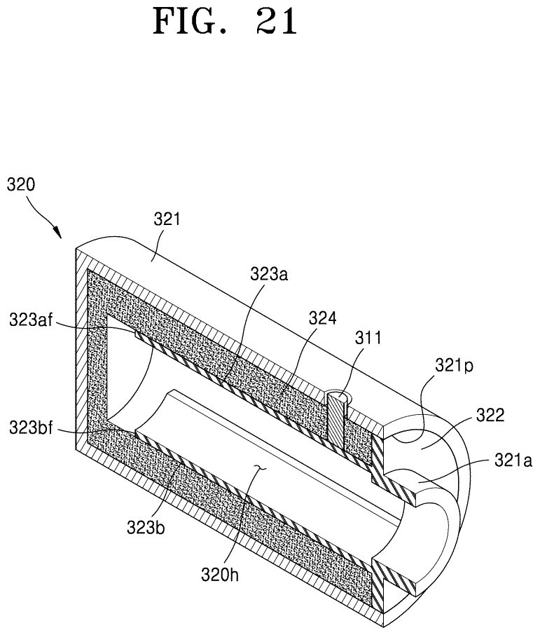

FIG. 21 is a schematic perspective view of a partially cutaway portion of a heater assembly according to another embodiment.

The heater assembly according to the embodiment of FIG. 21 may include a resonating unit 320 that generates microwave resonance and a coupler 311 that provides microwaves to the resonating unit 320.

The case 321 of the resonating unit 320 may include an accommodation space 320h for accommodating an aerosol generating article and an opening 321a through which the aerosol generating article may be inserted. The case 321 may have a cylindrical hollow shape extending in the lengthwise direction along which the aerosol generating article is inserted. The opening 321a of the case 321 may be formed in the connecting portion 322 connected to the case 321.

The ends of the plates 323a and 323b of the resonating unit 320 may be connected to the case 321 via the connecting portion 322. The connecting portion 322 has a substantially circular-plate shape, and the opening 321a, through which the aerosol generating article may be inserted, is formed at the center of the connecting portion 322. The connecting portion 322 may be mounted in an open mounting hole 321p at the front end of the case 321.

One or more embodiments are not limited to the structure in which the opening 321a is directly formed in the connecting portion 322, and the structure in which the opening 321a is formed in the case 321 may be variously changed. For example, as shown in the embodiment of FIG. 21, the opening 321a may be directly formed in the case 321 so that the opening 321a protrudes from the front end of the case 321. When the opening 321a is directly formed in the case 321, the connecting portion 322 may include a penetration hole, through which the aerosol generating article may pass, at the location corresponding to the opening 321a of the case 321.

The other ends of the plates 323a and 323b may open in the inner space of the case 321 towards the opposite side of the opening 321a.

The plates 323a and 323b may include the first plate 323a and the second plate 323b that are arranged apart from each other in the circumferential direction of the aerosol generating article accommodated in the accommodation space 320h.

The plates 323a and 323b extend in the lengthwise direction of the case 321. At least a portion of the plates 323a and 323b may be curved to protrude outward from the center of the accommodation space 320h in the lengthwise direction thereof. The accommodation space 320h may accommodate the aerosol generating article. The first plate 323a may be curved and extend in the circumferential direction of the aerosol generating article to surround a portion of the aerosol generating article. The second plate 323b may be curved and extend in the circumferential direction of the aerosol generating article to surround another portion of the aerosol generating article.

One end of the first plate 323a of the plates 323a and 323b and one end of the second plate 323b are connected to the connecting portion 322 and are spaced apart from each other and thus open. The space where the ends of the plates 323a and 323b are spaced apart from each other and open may be connected to the opening 321a.

The other end 323af of the first plate 323a of the plates 323a and 323b and the other end 323bf of the second plate 323b may be spaced apart from each other and thus open. Because other ends of the plates 323a and 323b are spaced apart from each other, an open end may be formed at the other ends of the plates 323a and 323b.

The resonating unit 320 may include a dielectric accommodation space to accommodate dielectrics. The dielectric accommodation space may be formed in the empty space between the case 321 and the plates 323a and 323b. In the dielectric accommodation space, dielectrics 324 with low microwave absorption may be accommodated.

The dielectrics 324 may have a cylindrical hollow shape with one end closed and the other end open. In the empty space in the dielectrics 324, the plates 323a and 323b may be inserted. The dielectrics 324 and the plates 323a and 323b may be mounted into the case 321.

The aerosol generating article may sequentially pass the spaces between the opening 321a and the ends of the plates 323a and 323b and may be mounted between the plates 323a and 323b. One end of the aerosol generating article may be supported by the closed end of the dielectric 324.

Unlike the embodiment shown in FIG. 11, in the heater assembly of FIG. 21, the location where the coupler 311 contacts the plates 323a and 323b has changed. The coupler 311 contacts regions of the plates 323a and 323b that are adjacent to the opening 321a.

One end of the coupler 311 contacts an oscillating unit (not shown). The coupler 311 penetrates the case 321 and the dielectrics 324. The other end of the coupler 311 may contact a portion of one end of the first plate 323a connected to the connecting portion 322.

As the microwaves generated from the oscillating unit (not shown) are transmitted to the first plate 323a through the coupler 311, microwave resonance may be formed in the resonating unit 320, thereby generating an electric field within the resonating unit 320.

In the heater assembly of FIG. 21, based on the structure in which the coupler 311 is arranged adjacent to the opening 321a, sufficient space may be secured for the arrangement of the oscillating unit (not shown) outside the case 321.

For example, the oscillating unit (not shown) connected to the coupler 311 may include components such as a circuit board that has a greater length than that of the case 321. According to the structure of the heater assembly of FIG. 21, the oscillating unit connected to the coupler may be positioned to extend along the lengthwise direction of the case 321 on the outside of the case 321. Therefore, even if the total length of the oscillating unit is great, space for the oscillating unit may be secured without significantly increasing the total length of the heater assembly, and thus, the heater assembly and the aerosol generating device may be miniaturized.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present invention should be defined by a reasonable interpretation of the appended claims, and all modifications that fall within the equivalent scope of the present invention are included in its scope.

### INDUSTRIAL APPLICABILITY

One or more embodiments provide a heater assembly capable of generating an aerosol by heating an aerosol generating article with a dielectric heating method and an aerosol generating device including the heater assembly.

1. A heater assembly for heating an aerosol generating article, the heater assembly comprising:
a resonating unit comprising: a case that comprises an accommodation space configured to accommodate the aerosol generating article and an opening through which the aerosol generating article is inserted; a plurality of plates arranged apart from each other along a circumferential direction of the aerosol generating article accommodated in the accommodation space; and a connecting portion connecting the plurality of plates to the case; and
a coupler configured to supply microwaves to at least one of the plurality of plates to generate microwave resonance in the resonating unit to heat the aerosol generating article.

2. The heater assembly of claim 1, wherein one ends of the plurality of plates are connected to the connecting portion, and other ends of the plurality of plates are spaced apart from each other and open.

3. The heater assembly of claim 2, wherein the other ends of the plurality of plates face the opening.

4. The heater assembly of claim 2, wherein the plurality of plates are symmetrically arranged with respect to the center of the aerosol generating article in a lengthwise direction of the aerosol generating article.

5. The heater assembly of claim 2, wherein the plurality of plates comprises two plates arranged at opposite locations with respect to the center of the aerosol generating article in a lengthwise direction of the aerosol generating article.

6. The heater assembly of claim 2, wherein the plurality of plates extend along a lengthwise direction of the aerosol generating article, and
at least a portion of the plurality of plates is curved to protrude outward from the center of the aerosol generating article in the lengthwise direction of the aerosol generating article.

7. The heater assembly of claim 1, wherein the coupler penetrates the case and contacts any one of the plurality of plates.

8. The heater assembly of claim 1, wherein the coupler is arranged adjacent to the connecting portion.

9. The heater assembly of claim 1, wherein the case is spaced apart from the plurality of plates.

10. The heater assembly of claim 1, wherein the case is spaced apart from the plurality of plates, and the heater assembly further comprises a dielectric between the case and the plurality of plates.

11. The heater assembly of claim 10, wherein an end of the dielectric protrudes towards the opening from the ends of the plurality of plates.

12. The heater assembly of claim 11, wherein the end of the dielectric is in contact with or spaced apart from an inner surface of the case.

13. The heater assembly of claim 1, further comprising a support tube inserted into the plurality of plates and configured to support the aerosol generating article.

14. The heater assembly of claim 1, wherein the plurality of plates extend in one direction, and a direction, along which the aerosol generating article is inserted into the accommodation space through the opening, intersects with the one direction.

15. An aerosol generating device comprising:
the heater assembly of claim 1; and
an oscillating unit configured to generate high-frequency microwave power and supply the high-frequency microwave power to the heater assembly.
